(19) United States
(12) Patent Application Publication
(10) Pub. No.: US 2015/0346660 A1
(43) Pub. Date: Dec. 3, 2015

(54) IMAGE FORMING APPARATUS

(71) Applicant: CANON KABUSHIKI KAISHA, Tokyo (JP)

(72) Inventors: Masatake Usui, Susono-shi (JP); Yasuharu Hirado, Mishima-shi (JP); Tomonori Sato, Gotemba-shi (JP); Takashi Nomura, Susono-shi (JP); Shuji Saito, Suntou-gun (JP); Hiroshi Kataoka, Suntou-gun (JP)

(21) Appl. No.: 14/726,895

(22) Filed: Jun. 1, 2015

(30) Foreign Application Priority Data
Jun. 2, 2014 (JP) 2014-114027

(51) Int. Cl. G03G 15/20

(52) U.S. Cl. CPC G03G 15/2039; G03G 15/2028

(57) ABSTRACT

An image forming apparatus includes a fixing portion for fixing a toner image on a sheet by heating the sheet while feeding the sheet, the fixing portion including a cylindrical film, a heater contacting an inner surface of the film, a roller cooperative with the heater to form the nip between the film and the roller; a sensor for detecting a heater temperature; a feed controller for controlling sheet feeding. In image formation on a second sheet continuously after forming the image on a first sheet, the sensor detects a temperature change in a predetermined period in which the nip does not feed the sheet and which is after the first sheet passes through the nip and before the second sheet reaches the nip, and the feed controller changes a feeding interval between the first and second sheets in accordance with the temperature change.

### FIELD OF THE INVENTION AND RELATED ART

The present invention relates to an image forming apparatus such as an electrophotographic printer, an electrophotographic copying machine, and the like.

As an example of fixing device which is installed in an electrophotographic printer and an electrophotographic copying machine, a fixing device of the so-called film heating type has been known. This type of fixing device has a heater having a ceramic substrate and a heat generating resistor placed on the substrate, a cylindrical fixation film which moves in contact with the heater, and a pressure roller which forms a nip in conjunction with the heater, with the presence of the fixation film between itself the fixation film. A sheet of recording medium, on which an unfixed toner image is present, is conveyed through the nip, remaining pinched between the pressure roller and fixation film. Thus, the toner image on the sheet of recording medium is fixed to the sheet of recording medium.

This type of fixing device has such a merit that it is short in the length of time (warm-up time) it takes for the temperature of the heater or fixation film to reach a level at which the fixation is possible, after the heater begins to be supplied with electric power. Therefore, a printer which employs this type of fixing device can reduce the length of time (FPOT: first printout time) it takes for the first image to be outputted after the inputting of a print command. Further, this type of fixing device has a merit that it is small in the amount by which it consumes electric power while the printer is waiting for a print command.

The fixation film and heater of a fixing device of the so-called film heating type are small in thermal capacity, and therefore, quickly warm up. In comparison, the pressure roller 152 of a fixing device of the film heating type is greater in thermal capacity that the fixation film and heater, and therefor, is slower to warm up than the fixation film and pressure roller. Further, an image forming apparatus which employs a fixing device of the above described type sometimes suffers from a problem that as the ambient temperature of the image forming apparatus changes, the fixation film becomes insufficient or excessive, in the amount of heat. If the fixing film becomes insufficient or excessive in the amount of heat, the toner image on the sheet of recording medium is likely to partially adhere to the surface of the fixation film; the fixing device 15 fails to reliably fix the toner image.

Regarding the above-described issue, in order to ensure that a fixing device remains reliable in fixation regardless of the changes in the ambient temperature of an image forming apparatus, various proposals have been made. According to one of such proposals, in order to change the wait time of a fixing device, that is, the length of time it takes for the fixing device to become ready for fixation, the length of time the fixation film is heated and the pressure roller 152 is rotated before the fixation is started, is extended. More concretely, there is disclosed in Japanese Laid-open Patent Application 2001-222183, a technology which equips the image forming apparatus with a sensor for detecting the ambient temperature, and changes a fixing device in the length of time its fixation film is rotated before the fixation is started, according to the temperature detected by the sensor.

It has been known that as moisture condenses on the peripheral surface of the pressure roller of a fixing device of the so-called film heating type, the friction between the pressure roller and fixation film reduces, making it impossible for the pressure roller to rotate the fixation film (hereafter, this phenomenon will be referred to simply as “condensation slip”). As described above, the fixation film and heater are small in thermal capacity, and the pressure roller is greater in thermal capacity than the fixation film and heater. Therefore, if a sheet of recording medium begins to be processed for fixation as soon as the temperature of the fixation film or heater reaches its target level, the pressure roller will not have been sufficiently warmed, and therefore, the water vapor from a sheet of recording medium is likely to condense on the peripheral surface of the pressure roller.

To describe the abovementioned condensation slip, as a sheet of recording medium on which an unfixed toner image is present is guided into the nip, water vapor is generated from the sheet during the process for heating the unfixed toner image. In a case where the peripheral surface of the pressure roller has not been sufficiently warmed up, the moisture (water vapor) condenses on the peripheral surface of the pressure roller. The fixation film is rotated by the friction which occurs between the outward surface of the fixation film and pressure roller in the nip as the pressure roller rotates. Therefore, as the friction is reduced by the effect of the moisture having condensed on the peripheral surface of the pressure roller, the fixation film sometimes reduces in speed, or temporarily stops, making it difficult for a sheet of recording medium to be properly conveyed. Thus, it is possible that the image bearing surface of the sheet of recording medium will suffer from scuffs attributable to the warping of the sheet, or the sheet becomes jammed in the fixing device.

The condensation slip is such a phenomenon that occurs to the second sheet and sheets thereafter in an image forming operation in which two or more prints are continuously made. That is, it does not occur to the first sheet, for the following reason. That is, the moisture which causes the condensation mainly comes from the sheet of recording medium in the nip. Thus, prior to the introduction of the first sheet into the nip, no moisture has condensed on the peripheral surface of the pressure roller. As for the means for preventing the condensation slip, it is effective to extend the length of time the pressure roller is rotated to be warmed up before the fixation process is started, as disclosed in Japanese Laid-open Patent Application 2001-222183.

However, the frequency of the occurrence of the condensation slip, and the extent of the condensation slip are affected by the condition of a sheet of recording medium in terms of moisture absorption, image pattern, pressure roller temperature, manner of apparatus usage, and cumulative length of apparatus usage. Therefore, in order to reliably prevent the occurrence of the condensation slip under the conditions in which the condensation slip might occur, the length of time the fixation film is to be rotated before the starting of the fixation process has to be set longer than the theoretically exact length of time the fixation roller needs to be rotated to prevent the condensation slip. Therefore, there is an issue that when there is little possibility that the condensation slip will occur, the fixation film 102 is rotated for an unnecessarily length of time before the starting of the fixation process.

### SUMMARY OF THE INVENTION

According to an aspect of the present invention, there is provided an image forming apparatus for forming a toner image to a recording material, said image forming apparatus comprising an image forming station for forming an unfixed toner image on a recording material; a fixing portion for fixing the unfixed toner image on the recording material by heating the recording material carrying the unfixed toner image in a nip while feeding the recording material, said fixing portion including a cylindrical film, a heater contacting an inner surface of said film, a roller cooperative with said heater to form the nip between said film and said roller; a temperature detecting portion for detecting a temperature of said heater; an electric power control portion for controlling electric power to be supplied to said heater so that a temperature detected by said temperature detecting portion is at a target temperature; and a feed control portion for controlling feeding of the recording material; wherein when the image is formed on a second recording material continuously after forming the image on the first recording material, said temperature detecting portion detects a change of the temperature of said heater in a predetermined period in which said nip does not feed the recording material and which is after the first recording material passes through said nip and before the second recording material reaches said nip, and said feed control portion changes a feeding interval between the first recording material and the second recording material in accordance with the change of the temperature.

According to another aspect of the present invention, there is provided an image forming apparatus for forming a toner image to a recording material, said image forming apparatus comprising an image forming station for forming an unfixed toner image on a recording material; a fixing portion for fixing the unfixed toner image on the recording material by heating the recording material carrying the unfixed toner image in a nip while feeding the recording material, said fixing portion including a rotatable heating member, a heater for heating said rotatable heating member, a pressing rotatable member cooperative with said rotatable heating member to form the nip between said rotatable heating member and said rotatable heating member; a temperature detecting portion for detecting a temperature of said rotatable heating member or said heater; an electric power control portion for controlling electric power to be supplied to said heater so that a temperature detected by said temperature detecting portion is at a target temperature; and a feed control portion for controlling feeding of the recording material; wherein when the image is formed on a second recording material continuously after forming the image on the first recording material, said feed control portion is capable of executing an operation in a first mode or an operation in a second mode, wherein in the first mode, said feed control portion controls feeding of the recording material such that a feeding interval between the first recording material and the second recording material is a predetermined feeding interval, and wherein said temperature detecting portion detects a change of the temperature of said heater in a predetermined period in which said nip does not feed the recording material and which is after the first recording material passes through said nip and before the second recording material reaches said nip, and said feed control portion controls the feeding interval between the first the recording material and the second recording material in accordance with the change of the temperature such that the feeding interval is longer than the predetermined interval.

According to a further aspect of the present invention, there is provided an image forming apparatus for forming a toner image to a recording material, said image forming apparatus comprising an image forming station for forming an unfixed toner image on a recording material; a fixing portion for fixing the unfixed toner image on the recording material by heating the recording material carrying the unfixed toner image in a nip while feeding the recording material, said fixing portion including a rotatable heating member, a heater for heating said rotatable heating member, a pressing rotatable member cooperative with said rotatable heating member to form the nip between said rotatable heating member and said rotatable heating member; a temperature detecting portion for detecting a temperature of said rotatable heating member or said heater; an electric power control portion for controlling electric power to be supplied to said heater so that a temperature detected by said temperature detecting portion is at a target temperature; a feed control portion for controlling feeding of the recording material; and an acquiring portion for acquiring a integrated value of a difference between the detected temperature and the target temperature in a predetermined period in which said nip does not feed the recording material and which is after a previous recording material passes through said nip and before a current the recording material reaches said nip, wherein said feed control portion controls feeding the recording material such that the feeding interval between the previous recording material and the current recording material is longer when the integrated value is larger than a threshold then when the integrated value is smaller than the threshold.

Further features of the present invention will become apparent from the following description of exemplary embodiments with reference to the attached drawings.

### BRIEF DESCRIPTION OF THE DRAWINGS

FIG. 1 is a sectional view of the image forming apparatus in the first embodiment of the present invention.

FIG. 2 is a sectional view of the fixing device in the first embodiment.

FIG. 3 is a drawing for describing the heater, and the power supply control circuit.

FIG. 4 is a drawing which shows the relationship between the temperature detected by a thermistor, and the temperature set for the heater, which occurred when it was possible that the condensation slip will occur.

FIG. 5 is a drawing which shows the relationship between the temperature detected by a thermistor, and the temperature set for the heater, which occurred when the condensation slip does not occur.

FIG. 6 is a drawing which shows the relationship between the slip index and the amount of the conveyance start time delay.

FIG. 7 is a drawing of timing charts for continuous image forming operations for consecutively outputting three prints, in the first and second modes, and mode in which the length of time the fixing member is rotated prior to the starting of the fixation process is extended.

FIG. 8 is a flowchart of the control sequence for preventing the condensation slip of the image forming apparatus in the first embodiment.

FIG. 9 is a block diagram of the control system (hardware) of the image forming apparatus, which carries out the control sequence, in the first embodiment.

FIG. 10 is a drawing which shows the relationship among the condition in which the condensation slip occurs, ambient temperature of the image forming apparatus, and ambient humidity of the image forming apparatus.

FIG. 11 is a drawing which shows the relationship among the condition in which the condensation slip occurs, ambient temperature of the image forming apparatus, and ambient humidity of the image forming apparatus.

FIG. 12 is a drawing which shows the relationship among the condition in which the condensation slip occurs, ambient temperature of the image forming apparatus, and ambient humidity of the image forming apparatus.

FIG. 13 is a flowchart of the control sequence for preventing the condensation slip of the image forming apparatus in the second embodiment of the present invention.

FIG. 14 is a block diagram of the control system of the hardware of the image forming apparatus, which carries out the control sequence, in the second embodiment.

FIG. 15 is a flowchart of the control sequence for preventing the condensation slip of the image forming apparatus in the third embodiment of the present invention.

FIG. 16 is a block diagram of the control system (hardware) of the image forming apparatus, which carries out the control sequence, in the third embodiment.

FIG. 17 is a drawing which shows the relationship between the slip index and the extent of image scuffing which occurred when the control sequence shown in FIG. 15 was not executed.

FIG. 18 is a drawing which shows the relationship between the slip index and the extent of image scuffing which occurred when the control shown in FIG. 15 was executed.

FIG. 19 is a drawing which shows the relationship between the temperature detected by the thermistor and the set temperature, which occurred when the timing with which the second sheet of recording medium is to be conveyed was delayed (normal condition).

FIG. 20 is a drawing which shows the relationship between the temperature detected by the thermistor and the set temperature, which occurred when the timing with which the second sheet of recording medium is to be conveyed was delayed (abnormal condition).

FIGS. 21A and 21B are a flowchart of the control sequence for preventing the condensation slip of the image forming apparatus in the fourth embodiment of the present invention.

FIG. 22 is a drawing which shows the relationship between the slip index and the amount of delay of the conveyance start time.

FIG. 23 is a flowchart of the control sequence for the first sheet of recording medium, which is carried out in S408 in FIGS. 21A and 21B.

FIG. 24 is a block diagram of the control system (hardware) of the image forming apparatus, which carries out the control sequence.

FIG. 25 is a drawing which shows the relationship among the control slip occurrence area, ambient temperature of the image forming apparatus, and ambient humidity of the image forming apparatus.

FIG. 26 is a sectional view of the fixing device installed in the image forming apparatus in the fifth embodiment of the present invention.

FIG. 27 is a drawing which shows the relationship between the temperature detected by the thermistor and the set temperature, which occurred when it was possible that the condensation slip would occur.

FIG. 28 is a sectional view of the fixing device installed in the image forming apparatus in the sixth embodiment of the present invention.

FIG. 29 is a sectional view of the fixing device in the seventh embodiment of the present invention.

FIG. 30 is drawing which shows the relationship between the temperature detected by the thermopile and the set temperature, which occurred when it was possible that the condensation slip would occur.

### DESCRIPTION OF THE EMBODIMENTS

Hereinafter, embodiments of the present invention are described with reference to the appended drawings. The following embodiments of the present invention are some of the preferable examples of the embodiments of the present invention. However, they are not intended to limit the present invention in scope. That is, the present invention is also applicable to image forming apparatuses which are different in structure from those in the following embodiments, within the scope of the invention.

### Embodiment 1

### (1) Image Forming Apparatus

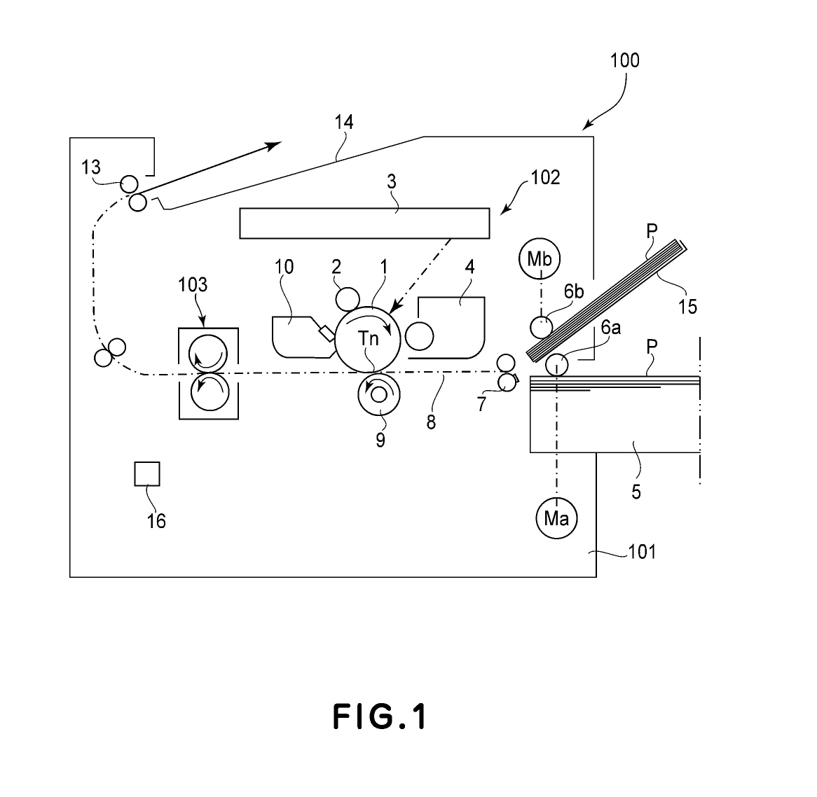

First, referring to FIG. 1, the image forming apparatus in this embodiment is described. FIG. 1 is a sectional view of the image forming apparatus 100 (monochromatic printer) in this embodiment, which uses one of electrophotographic recording technologies. It shows the general structure of the apparatus.

The image forming section 102 of the image forming apparatus 100, which forms a toner image on a sheet P of recording medium, has: a photosensitive drum as an image bearing member; a charging member 2; and a laser scanner 3. It has also: a developing device 4; a cleaner 10 which cleans the peripheral surface of the photosensitive drum 1; and a transferring member. The operation of this image forming section 102 is well known, and therefore, is not described here.

The sheets P of recording medium in a cassette 5 installed in the main assembly 100 of the image forming apparatus 100 begin to be conveyed to a pair of rollers 7 by the rotation of a roller 6a. The sheets P of recording medium on a tray 15 with which the image forming apparatus main assembly 101 is provided begin to be conveyed to the pair of rollers 7 by the rotation of a roller 6b. A referential code Ma stands for a motor which rotationally drives the roller 6a. A referential code Mb stands for a motor which rotationally drives the roller 6b. As a sheet P of recording medium is conveyed into the image forming apparatus main assembly 101, it is conveyed by the rotation of the pair of rollers 7 through a recording medium conveyance passage 8 as a recording medium conveyance section, to a transferring section Tn which is formed by the photosensitive drum 1 and transferring member 9.

After a toner image is transferred onto the sheet P of recording medium in the transferring section Tn, the sheet P is guided by a recording medium conveyance passage 8 to a fixing device 103 (fixing section), in which the toner image is thermally fixed to the sheet P. After being conveyed out of the fixing device 103, the sheet P is guided by the recording medium conveyance passage 8, to a pair of rollers 13. Then, it is discharged into a tray 14 by the rotation of the pair of rollers 13.

A referential code 16 stands for a temperature-humidity sensor as a temperature-humidity detecting means. The temperature-humidity sensor 16 is attached to the apparatus main assembly 101 in such a manner that it is enabled to measure the ambient temperature and humidity of the image forming apparatus 100, as the information about the ambience in which the image forming apparatus 100 is disposed.

### (2) Fixing Device 103

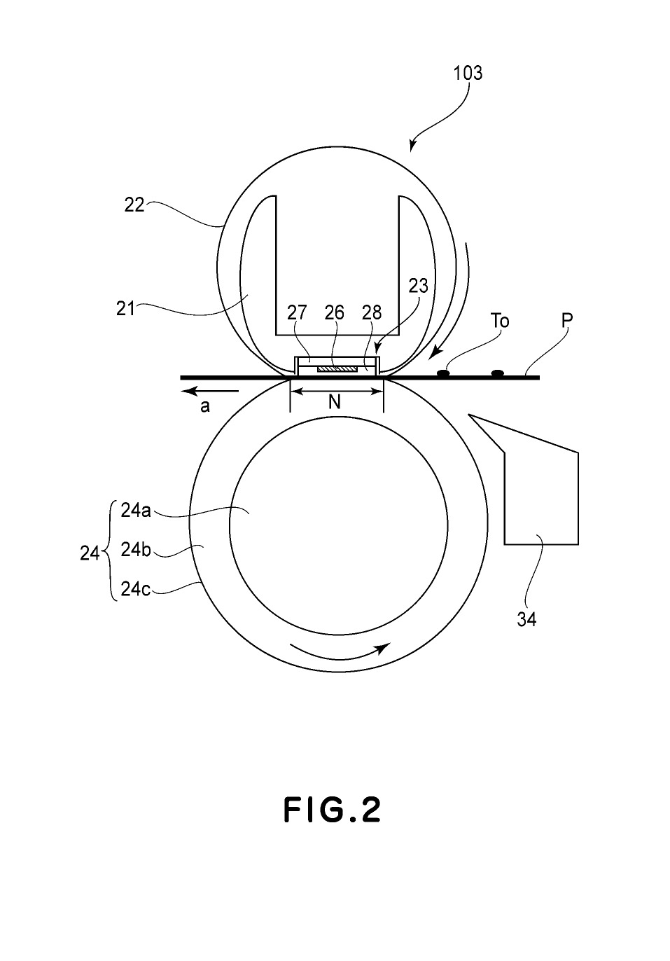

FIG. 2 is a sectional view of the fixing device 103. The fixing device 103 is of the so-called film heating type. This fixing device 103 has a cylindrical fixation film 22 (rotational heating member), a pressure roller 24 (rotational heating member), a heater 23, and a stay 21 (holding member).

The heater 23 is held by the stay 21 which is heat resistant and rigid, in such an attitude that it becomes perpendicular to the direction a in which the sheet P of recording medium is conveyed. The stay 21 is made of heat resistant resin, such as polyamide, poly amide-imide, PEEK, PPS, liquid polymer, etc., or compound material made of a combination of one of the preceding resins, and ceramic, metal, glass, etc. In this embodiment, liquid polymer is used as the material for the stay 21.

The fixation film 22 is loosely fitted around the peripheral surface of the stay 21 which is holding the heater 23. For the purpose of enabling the fixing device 103 to quickly start up by reducing the fixing device 103 in thermal capacity, the thickness of the fixation film 22 is desired to be no more than 100 μm, preferably, no more than 80 μm and no less than 20 μm. As the material for the fixation film 22, a mono-layer film formed of PTFE, PFA, FEP, or the like, which are heat resistant, is used. Further, the material for the fixation film 22 may be multilayer film made by coating the outward surface of the film made of polyamide-imide, PEEK, PES, PPS, or the like, with PTFE, PFA, REP, or the like. In this embodiment, film made by coating the outward surface of polyamide film, which is roughly 60 μm in thickness, with PTFE, is used as the material for the fixation film 22. The external diameter of the fixation film 22 is 24 mm.

The pressure roller 24 is made up of a metallic core 24a, an elastic layer 24b formed on the peripheral surface of the metallic core 24a, and a release layer 24c, as the outermost layer, formed on the peripheral surface of the elastic layer 24b. The overall thermal capacity of this pressure roller 24 is greater than that of the film 22. Both of the lengthwise ends of the metallic core 24a are rotatably supported by the frame (unshown) of the fixing device 103, with the placement of a pair of bearings (unshown) between the metallic core 24a and frame. The pressure roller 24 is kept pressed against the heater 23, with the presence of the film 22 between the pressure roller 24 and heater 23, by the pressure applied to the lengthwise ends of the metallic core 24a by a pair of compression springs (unshown), in the direction perpendicular to the generatric of the pressure roller 24. Thus, a nip N is formed between the peripheral surface of the pressure roller 24 and film 22.

In this embodiment, the material for the metallic core 24a is aluminum, and the material for the elastic layer 24b is silicone rubber. The material for the release layer 24c is a piece of PFA tube which is roughly 50 μm in thickness. The external diameter of the pressure roller 24 is 30 mm, and the thickness of the elastic layer 24b is 3 mm. The hardness of the pressure roller 24 is 55° (Asker C). The amount of the pressure applied to the film 22 is 200 N.

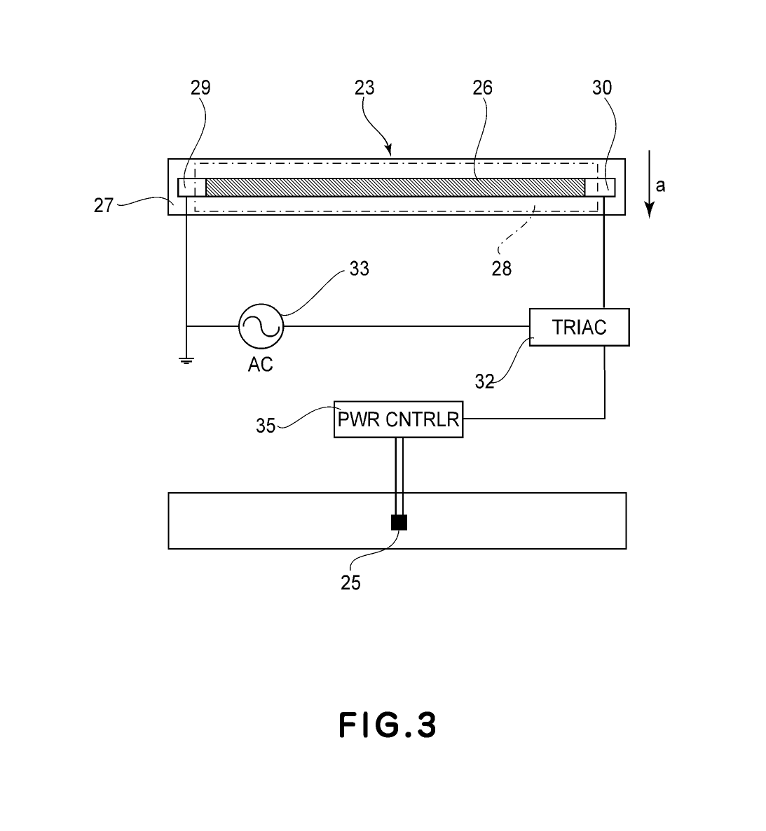

FIG. 3 is a combination of the front view of the heater 23, and the circuit which controls the power supply to the heater 23. The heater 23 has a long and narrow rectangular substrate 27, which is heat resistant, electrically insulating, and thermally conductive. The heater 23 has also a heat generating resistor 26 which is formed on the downwardly facing surface (surface on which the film 22 slides) of the substrate 27 in such an attitude that it extends in the lengthwise direction of the substrate 27, and which generates heat as it is supplied with electric power, an overcoat layer 28 which protects the heat generating resistor 26, and a pair of electrodes 29 and 30 for supplying the heat generating resistor 26 with electric power. The overall thermal capacity of this heater 23 is smaller than that of the pressure roller 24. The resistance value of the heat generating resistor 26 is 10Ω in the normal temperature range.

As the material for the substrate 27, ceramic such as alumina, aluminum nitrate, or the like, is used. In this embodiment, the substrate 27 is made of aluminum, and is 10 mm in width, 370 mm in length, and 1 mm in thickness. The main roles of the overcoat layer 28 are to provide the heat generating resistor 26 with electrical insulation, and to ensure that film 22 is enabled to easily slide on the heater 23. In this embodiment, the overcoat layer 28 is formed of heat resistant glass, and is roughly 50 μm in thickness.

FIG. 3 shows the back surface of the heater 23 (surface on which the film 22 does not slide) as well. A referential code 25 stands for a thermistor (temperature detecting means), which is a temperature detection element provided to detect the temperature of the heater 23. The thermistor 25 is disposed within such a portion of the recording medium conveyance range, in terms of the direction perpendicular to the recording medium conveyance direction a, that ensures that the thermistors 25 will be within the path of a sheet P of recording medium regardless of the size of the sheet P.

As the heat generating resistor 26 is supplied with electric power by an electric power source 33 through the electrodes 29 and 30, the heat generating resistor 26 generates heat across its entirety in terms of its lengthwise direction. As a result, the heater 23 increases in temperature. As the heater 23 increases in temperature, its temperature is detected by the thermistor 25, and the temperature detected by the thermistor is A/D converted. The converted signals are taken up by an electric power controlling section 35 which comprises a CPU and memories such as ROM and RAM. The controlling section 35 controls the amount by which electric power is supplied to the heat generating resistor 26, based on the temperature detected by the thermistor, with the use of a Triac 32, in order to control the heater 23 in temperature. That is, the controlling section 35 controls the heater 23 so that if the temperature detected by the thermistor is lower than a preset temperature (target temperature), the heater 23 increases in temperature, whereas if the temperature detected by the thermistor 2 is higher than the preset temperature, the heater 23 decreases in temperature. Thus, the temperature of the heater 23 is kept stable at a preset level during the fixation.

In this embodiment, a commercial AC power is used to cause the heater 23 to generate heat. More specifically, the commercial AC power is controlled in the phase in terms of its waveform so that it can be controlled in its output in 21 steps, that is, by an increment of 5% in an output range of 0-100%. An output of 100% corresponds to the highest output of the power source.

### (2-1) Fixing Operation of Fixing Device 103

Next, referring to FIGS. 2 and 3, the fixing operation of the fixing device 103 is described. As the driving force from the motor (unshown) with which the apparatus main assembly 101 is provided is transmitted to a gear (unshown) of the metallic core 24a of the pressure roller 24, the pressure roller 24 rotates in the direction indicated by an arrow mark. Thus, the film 22 is rotated by the rotation of the pressure roller 24 in the direction indicated by an arrow mark, while sliding on the overcoat layer 28 by is inward surface.

As the heat generating resistor 26 of the heater 23 is supplied with electric power by the electric power source 33 through the electrodes 29 and 30, the heat generating resistor 26 generates heat, whereby the heater is quickly increased in temperature. The controlling section 50 turns on or off the Triac 32 to control the amount by which electric power is supplied to the heater 23, so that the temperature detected by the thermistor 25 remains stable at the preset level (target level).

After the temperature of the heater 23 increases to the preset level, and the peripheral velocity with which the film 22 is rotated by the rotation of the pressure roller 24 becomes stable at a preset one, a sheet P of recording medium, on which an unfixed toner image To is present, is guided into the nip N by an entrance guide 34. In this embodiment, the film 22 is continuously rotated by the pressure roller 24 until the temperature of the heater 23 increases from the level at which it was when the heater 23 began to be increased in temperature, to the preset level (target level) (pre-fixation rotation). Then, a sheet P of recording medium begins to be introduced into the nip N.

The sheet P having the unfixed toner image To is heated in the nip N while being conveyed through the nip N, remaining pinched between the film 22 and pressure roller 24. Thus, the toner image is thermally fixed to the sheet P.

### (2-2) Method for Preventing Condensation Slip

Next, the method used by the image forming apparatus 100 in this embodiment to prevent the occurrence of the condensation slip, which characterizes the image forming apparatus 100 is described. The image forming apparatus in this embodiment is enabled to operate in the first or second printing mode, in an image forming operation in which images are continuously formed on two or more sheets P of recording medium. In the first printing mode (first mode), the second sheet P (following sheet P) is conveyed to the fixing device 103 with a preset conveyance timing after the passage of the first sheet P (preceding sheet) through the nip N. That is, the conveyance interval between the preceding and following sheets is preset and is kept unchanged. In the second printing mode, after the passage of the first sheet P of recording medium through the nip N, the film 22 is examined in the state of rotation while no sheet P is in the nip N. Then, the conveyance timing with which the second sheet P is to be conveyed to the nip N is set based on the results of the examination.

Whether the image forming apparatus 100 is to be operated in the first or second printing mode is decided based on the temperature and humidity (temperature-humidity information) detected by the temperature-humidity sensor 16. When the image forming apparatus 100 is operated in the second printing mode, a slip index is measured (obtained by calculation), to determine whether or not it is possible that the condensation slip will occur.

### <Explanation of Slip Index>

Next, the slip index used in this embodiment is explained. The slip index is the amount of difference between the temperature detected by the thermistor (which hereafter may be referred to as thermistor temperature), and the set temperature (target temperature). The timing with which the amount of the difference is obtained is right after the entirety of the first sheet P of recording medium comes out of the nip N (after the passage of the sheet P through the nip N).

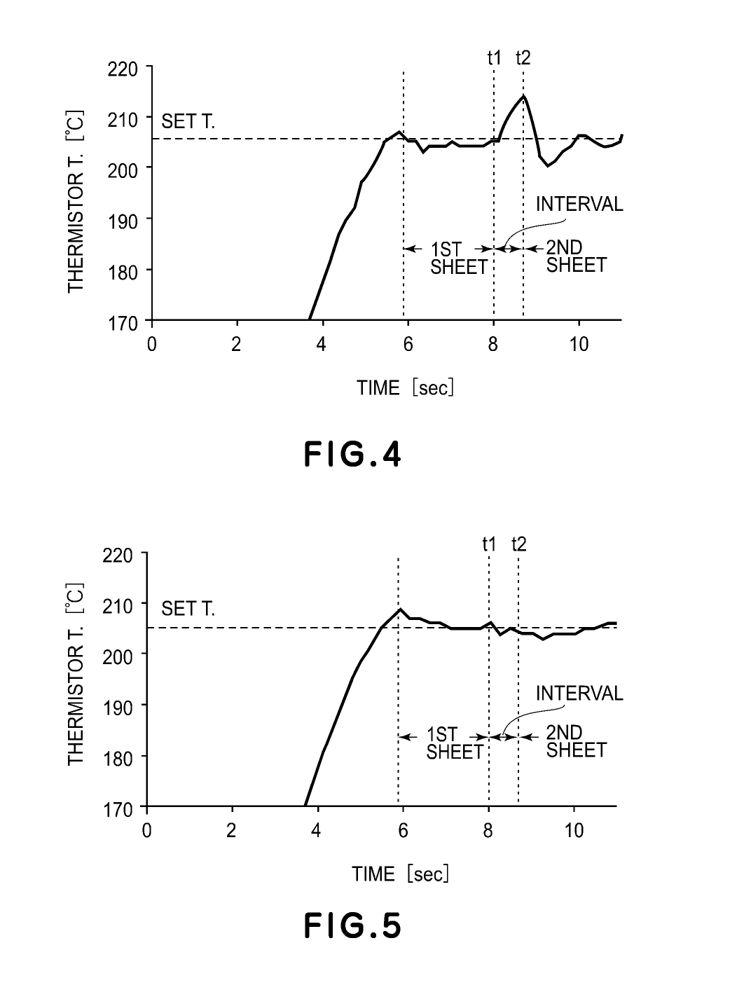

FIG. 4 shows the relationship between the thermistor temperature and set temperature (target temperature), which occurred when it was possible that the condensation slip would occur. When the set temperature was 205° C., the monitored thermistor temperature overshot the set temperature, reaching as high as 215° C., during a sheet interval t1-t2 between the first and second sheets P of recording medium, and then, it undershot the set temperature, decreasing as low as 200° C. The cause of the overshoot and undershoot is that the film remained stationary during the sheet interval t1-t2.

As the film 22 is suddenly reduced in speed, or stopped, while it is rotated, the heat which was being moved out of the nip N by the rotation of the film 22 is prevented from being moved out of the nip N. Thus, the heat accumulates in the nip N. As the heat accumulates in the nip N, the back surface of the heater 23 increases in temperature. Thus, the thermistor 25 which is in contact with the back surface of the heater 23 increases in temperature. Thus, the difference between the temperature detected by the thermistor 25 and the set temperature (target temperature) also increases. Thus, the controlling section 50 reduces the amount of heat generation to lower the thermistor temperature to the set temperature. This is why the undershoot occurs right after the occurrence of the overshoot. The overshoot is greater when the film 22 is being moved at a reduced speed than when the film 22 is stationary. Further, the greater the length of time the film 22 remains stationary, the greater the overshoot. Thus, whether or not the condensation slip will occur can be determined based on the changes which occur to the temperature detected by the thermistor 25, as the film 22 reduces in rotational speed.

FIG. 5 shows the relationship between the set temperature and thermistor temperature, which occurred when the condensation slip did not occur. During the recording medium interval t1-t2, the thermistor temperature and set temperature are roughly the same. This means that because the film 22 was normally rotating, the thermistor temperature remained relatively stable, being virtually the same as the set temperature.

Next, the method for calculating the slip index is described. One example of the slip index is the value obtained by integrating the difference between the set temperature and thermistor temperature. The following is a mathematical formula for calculating the slip index.

∫ₜ₁^{t2}ΔTdt (1)

Δ T stands for the amount of difference between the set temperature and the thermistor temperature; t1 stands for the point in time at which the first sheet P of recording medium comes out of the nip N; and t2 sands for the point in time at which the second sheet P of recording medium reaches the nip N in the first printing mode. By the way, the period t1-t2 may be any part of the period which comes after the passage of the preceding sheet of recording medium through the nip N, and before the following sheet of recording medium reaches the nip N, and in which no sheet of recording medium is being conveyed through the nip N.

Referring to FIG. 4, when the film 22 is stationary and the thermistor temperature is not higher than the set temperature, the slip index is large. Referring to FIG. 5, when the film 22 is moving and the temperature control is normally executed, the slip index is small.

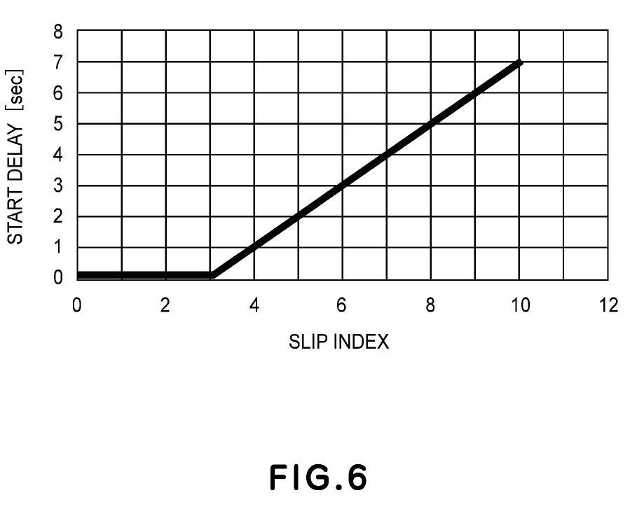

The larger the slip index, the longer the conveyance start timing for the next sheet of recording medium has to be delayed to prevent the occurrence of the condensation slip. When the slip index is small, the condensation slip does not occur. Therefore, it is unnecessary to delay the conveyance start timing. It has been proven by experiments that under the conditions under which the image forming apparatus 100 (fixing device 103) in this embodiment was tested, as long as the slip index is no greater than 3, it was unnecessary to delay the conveyance start timing, whereas when the slip index was greater than 3, it was necessary to delay the conveyance start timing based on the amount of increase of the slip index. FIG. 6 shows the relationship between the slip index and the length of time by which the conveyance start timing had to be delayed. For example, when the slip index was 5, the conveyance start timing had to be delayed by two seconds in order to prevent the occurrence of the condensation slip.

### <Timing Chart>

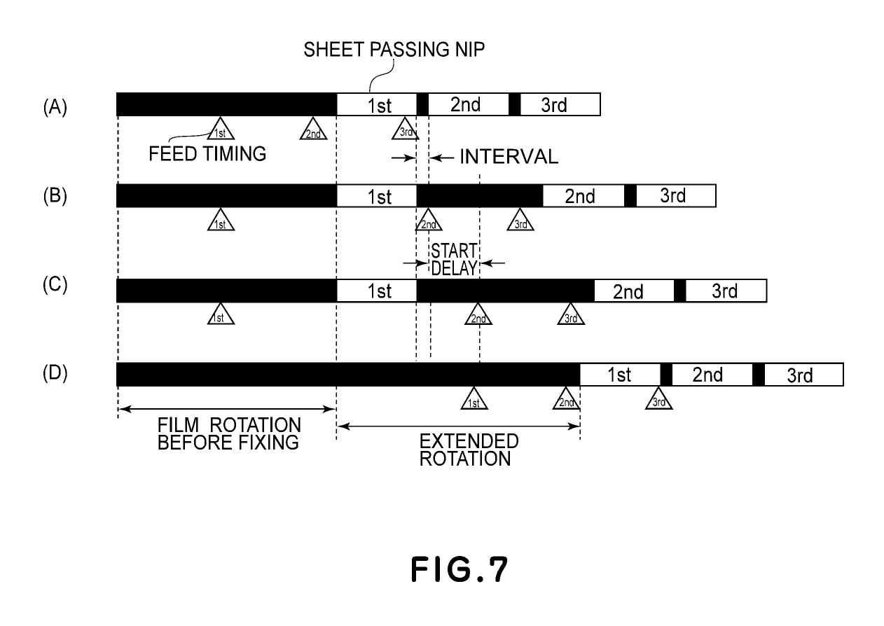

FIG. 7 is a timing chart for an image forming operation in which an image is consecutively formed on three sheets of preceding paper. It shows the relationship between the timing with which a sheet P of recording medium begins to be conveyed by the roller 6a or 6b, and the timing with which the entirety of the sheet P came out of the nip N.

FIG. 7(A) is a timing chart for an image forming operation carried out in the first printing mode, in which two or more sheets P of recording medium are consecutively conveyed. In the first printing mode, the conveyance of the second sheet P of recording medium is started before the first sheet P reaches the nip N. Here, the preset conveyance interval is the interval between the preceding and following sheets in the first printing mode.

FIG. 7(B) is a timing chart for a case in which the condensation slip will possibly occur (in the second mode), but it was determined based on the slip index that the condensation slip will not occur. The slip index is calculated during the recording medium interval which occurs as the first sheet P completely comes out of the nip N. Then, the conveyance of the second sheet is started as soon as the slip index is calculated. In a case where the slip index is obtained in the second printing mode, the obtained slip index is reflected upon the conveyance interval between the preceding and following sheets P. Thus, the conveyance interval becomes longer than the preset conveyance interval for the first printing mode.

FIG. 7(C) is a timing chart for a case where it is possible that the condensation slip will occur, and therefore, the image forming apparatus is operated in the second mode. That is, it is a timing chart for a case where it was determined based on the slip index that the condensation slip will occur. Thus, the slip index is obtained in the recording medium interval which occurs between the point in time at which the first sheet P of recording medium completely moved out of the nip N, and the point in time at which the second sheet P reaches the nip N. Then, the conveyance of the second sheet P is started with such a timing that makes the length of the conveyance interval between the first and second sheets P proportional to the slip index.

FIG. 7(D) is a timing chart for a case where the above described prior art which changes the length of time the film 22 is rotated before the starting of the fixation process, based on the ambient temperature is used as a means for dealing with the condensation slip. The length of time the film 22 is rotated before the starting of the fixation process is set according to the amount of moisture in the sheet P and printing ratio. Therefore, the length of time the film 22 is rotated before the first sheet P is introduced into the nip N is longer than that in this embodiment.

### <Description of Control>

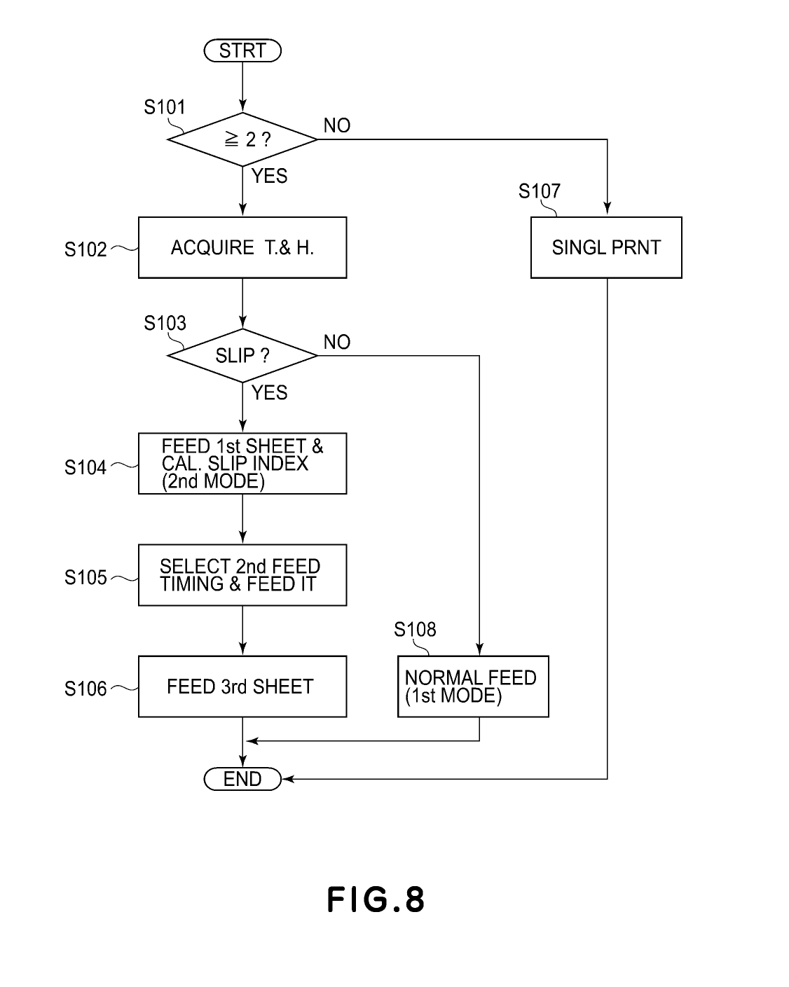

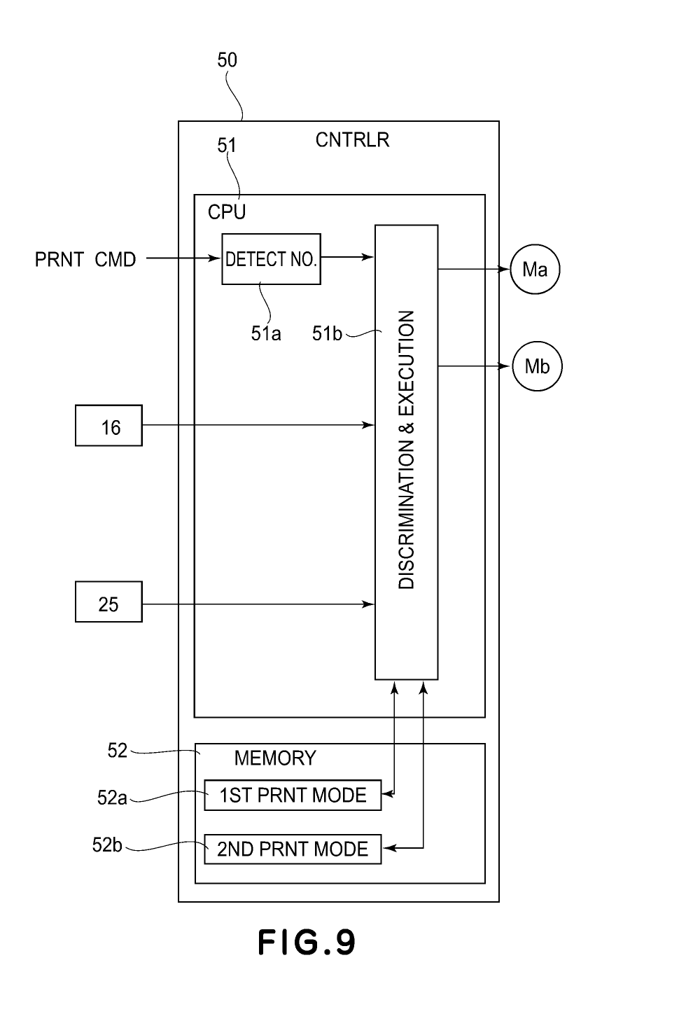

FIG. 8 is a flowchart of the control sequence, in this embodiment, for preventing the condensation slip. One of the characteristics of the image forming apparatus 100 in this embodiment is that whether the image forming apparatus 100 is to be operated in the first or second printing mode is determined based on the temperature-humidity combination detected by the temperature-humidity sensor 16. FIG. 9 is a block diagram of the control system (hardware) which carries out the control sequence shown in FIG. 8. The controlling section 50 comprises the CPU 51, memory 52 such as ROM and RAM. In the memory 52, the first and second printing modes 52a and 52b are stored.

The determining-executing section 51b of the CPU 51 determines whether or not the inputted printing job is a printing operation for consecutively printing two or more prints, based on the print count which a print count detecting section 51a of the CPU 51 obtains from the print count information in a print command (S101). If the controlling section 50 determines that the printing job is for printing only one print (N), it proceeds to S107, in which it outputs one print and ends the printing operation. If it determines that the printing job is for consecutively outputting two or more prints (continuous printing operation) (Y), it proceeds to S102, in which it takes in the temperature and humidity which the temperature-humidity sensor 16 detected.

In S103, the controlling section 50 determines, based on the temperature and humidity, whether or not there is a possibility that the condensation slip will occur. If it determines that the temperature and humidity are such that there is no possibility that the condensation slip will occur (N), it proceeds to S108, in which it carries out the printing operation in the first printing mode, in which it consecutively conveys sheets P of recording medium with the normal recording medium interval. If it determines that the temperature and humidity are such that it is possible that the condensation slip will occur (Y), it proceeds to S104.

In S104, the controlling section 50 operates the image forming apparatus 100 in the second printing mode 52b, in which the slip index is calculated to determine whether or not it is possible that the condensation slip will occur, based on how the film 22 rotates during the recording medium interval, which occurs immediately after the first sheet P of recording medium came out of the nip N, as described above, during the above given explanation of the slip index. In S105, the controlling section 50 sets the conveyance timing for the second sheet, based on the slip index obtained in S104, and conveys the second sheet, with the set timing. Then, it proceeds to S106, in which it conveys the third sheet and the sheets thereafter with the same recording medium intervals as in the first printing mode.

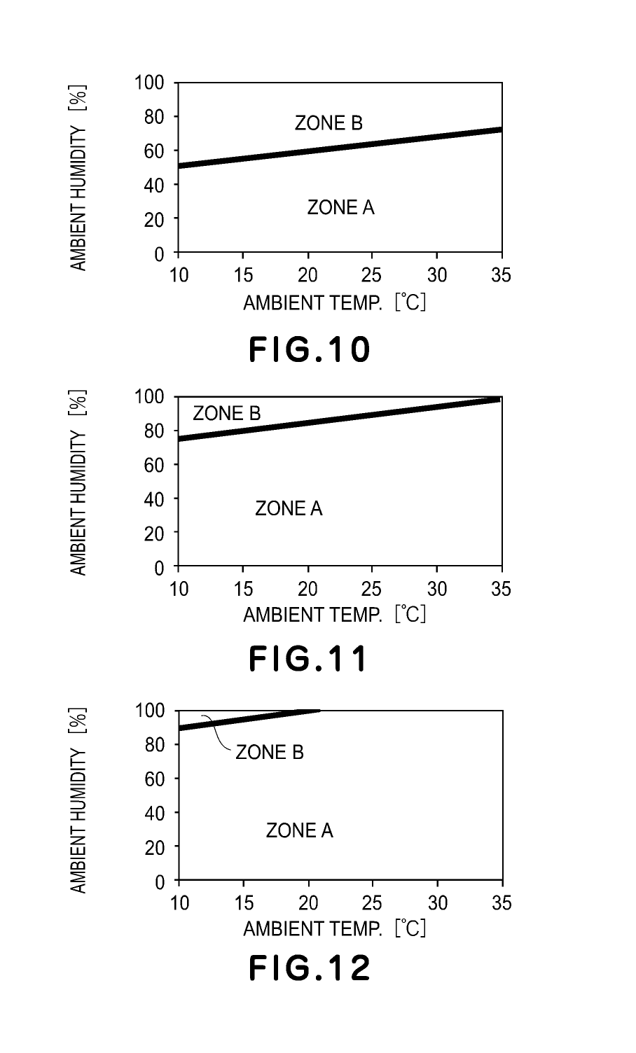

Next, the method for determining, in S103, whether or not the detected temperature and humidity are such that they will cause the condensation slip, is described. FIG. 10 shows the relationship between the ambient temperature and humidity, which is related to the occurrence or nonoccurrence of the condensation slip. The area of FIG. 10, in which the condensation slip occurs, corresponds to a case where the first print, to which the occurrence of the condensation slip is attributable, is 100% in printing ratio, that is, a case where the entirety of the sheet P is covered with toner. A print which is 100% in printing ratio is such a print that its image bearing surface is entirely covered with toner. Therefore, it is difficult for the moisture in the sheet P to evaporate in the form of water vapor from the covered side of the sheet P. That is, the moisture in the sheet P is likely to evaporate in the form of water vapor from the surface of the sheet P, which is not covered with the toner. Thus, the moisture (water vapor) from the sheet P is likely to condense on the pressure roller 24, making it more likely for the condensation slip to occur.

The lower the ambient temperature, the more likely it is for the condensation slip to occur, because, the lower the temperature, the more difficult it is for the pressure roller 24 to warm up, and therefore, the more likely it is for the moisture (water vapor) from the sheet P to condense on the pressure roller 24. Further, the higher the ambient humidity, the more likely it is for the condensation slip to occur, because the higher the ambient humidity, the greater the amount of moisture in a sheet P of recording medium left unattended for a substantial length of time, and therefore, the greater the amount by which water vapor is generated from the sheet P while the sheet P is processed for image fixation. In this embodiment, the first printing mode is selected in a case where the relationship between the ambient temperature and ambient humidity is in Zone A, in which the condensation slip does not occur, whereas the relationship is in the Zone B, in which it is possible for the condensation slip will occur, the second printing mode is selected.

### <Results of Verification Tests>

The effectiveness of the condensation slip preventing method in this embodiment was verified by conveying sheets P of recording medium under two conditions which are different in temperature-humidity. The conditions under which the sheets P were conveyed are as follows. One (first) condition is such that the temperature-humidity combination was 23° C./50%, which was in Zone A in which the condensation slip does not occur, and the other (second) condition is such that the temperature-humidity combination was 23° C./80%, which was in Zone B, in which the condensation slip possibly occurs. The sheets P of recording medium (paper in Tables 1 and 2) used for the verification tests were CS-680 (product of Canon Marketing Japan). The printing speed was set to 20 ppm.

Regarding the condition (state) of the sheets P, one (first) set of sheets P was used immediately after the unsealing of the package in which the sheets P were contained, whereas the other (second) set of sheets P was used after it was left unattended for a substantial length of time after the unsealing of the package in which the sheets P were contained. The printing ratio was set to 100%. That is, the image formed on the sheets P was such an image that covers the entirety of the image bearing surface of each sheet P. For comparison, the same images were continuously printed without changing (switching) the image forming apparatus in printing mode. Then, the resultant prints were evaluated using the same criteria as those used for evaluating the prints made while the condensation slip preventing method in this embodiment was in use. Table 1 shows the results of evaluation of the images formed with the use of the condensation slip preventing method in this embodiment, along with the evaluation of the images formed without using the condensation slip preventing method in this embodiment.

TABLE 1

| | | | | | | Image |
|---|---|---|---|---|---|---|
| Temp. | | | | | Delay | defects |
| (deg. | Humid. | States of | | Slip | Time | by dew |
| C.) | (%) | Sheets | Modes | Index | (sec) | slip |
| 23 | 50 | Just after | 1^{st} | — | 0 | No |
| | | unsealed | | | | |
| 23 | 50 | Left unused | 1^{st} | — | 0 | No |
| | | after | | | | |
| | | unsealed | | | | |
| 23 | 80 | Just after | 2^{nd} | 0 | 0 | No |
| | | unsealed | | | | |
| 23 | 80 | Left unused | 2^{nd} | 5 | 2 | No |
| | | after | | | | |
| | | unsealed | | | | |

Under the first condition which was 23° C. in temperature and 50% in humidity, and therefore, was in Zone A in FIG. 10, the first printing mode was selected. In this case, the condensation slip did not occur regardless of whether the sheets P were used immediately after the unsealing of the package, or after they were left unattended for a substantial length of time after the unsealing of the package. Under the second condition which was 23° C. in temperature and 80% in humidity, the ambient temperature and humidity were 23° C. and 50%, and therefore, was in Zone B in FIG. 10, the second printing mode was selected. In the case of the sheets P which were fresh out of the package, the slip index was 0, and the condensation slip did not occur even though the sheet interval was not extended. In the case of the sheets P which were not fresh out of the package, the slip index was 5. In this case, it was possible to prevent the occurrence of the condensation slip, by extending the recording medium interval by two second. That is, the length of time by the sheet interval is to be extended was set according to the state of a sheet P of recording medium in terms of moisture absorption, and therefore, it was properly set.

Table 2 shows the results of the evaluation tests of the comparative continuous image forming operation, in which the image forming apparatus was not changed in printing mode; it was operated in the first printing mode.

TABLE 2

| Temp. | Humid. | | | Image defects |
|---|---|---|---|---|
| (deg. C.) | (%) | States of Sheets | Modes | by dew slip |
| 23 | 50 | Just after unsealed | 1^{st} | No |
| 23 | 50 | Left unused after | 1^{st} | No |
| | | unsealed | | |
| 23 | 80 | Just after unsealed | 1^{st} | No |
| 23 | 80 | Left unused after | 1^{st} | Yes |
| | | unsealed | | |

Only in a case where the continuous printing operation was carried out with the use of sheets of paper which were left unattended for a substantial length of time under the condition which was 23° C. in temperature and 80% in humidity, the condensation slip occurred.

As described above, in this embodiment, it is determined, based on the combination of ambient temperature and humidity, whether the first or second printing mode is to be selected, and the conveyance timing for the second sheet P of recording medium is set based on the slip index which is calculated as the second printing mode is selected. By executing a control sequence such as the above described one, it is possible determine whether or not it is possible for the condensation slip will occur, and therefore, it is possible to prevent the recording medium interval from being unnecessarily extend.

Also as described above, it is possible to prevent the occurrence of the condensation slip, without extending the length of time by which the film 22 (pressure roller) is rotated prior to the starting of the fixation process. Since the image forming apparatus 100 is enabled to operate in the first printing mode which is for the ambient condition in which the condensation slip does not occur, or the second printing mode which is for the ambience in which the condensation slip possibly occurs. Therefore, the image forming apparatus can be switched in operational mode according to the condition (temperature-humidity combination) under which it is operated.

Further, in a case where the image forming apparatus 100 is used to consecutively form images on two or more sheets P of recording medium, the state of rotation of the film 22 is detected while no sheet P is in the nip N, and the timing with which the sheet P is to be conveyed can be set based on the result of the detection. If the image forming apparatus 100 is operated in the second printing mode, in the ambience in which the condensation slip does not occur, and the default recording medium interval is short, the recording medium interval has to be extended to detect the state of rotation of the film 22. Thus, the image forming apparatus 100 reduces in productivity, which is problematic. This problem, however, can be solved by enabling the image forming apparatus 100 to be operated in the first or second printing mode.

Further, even in a case where the image forming apparatus 100 is operated in the second printing mode which is for the ambience in which the condensation slip possibly occurs, it is possible to determine whether or not the condensation slip will actually occur, and the extent of the expected slippage. Therefore, the timing with which the second sheet P of recording medium is to be conveyed can be properly set. That is, the occurrence of the condensation slip can be prevented, without unnecessarily extending the recording medium interval. Further, in the second mode, whether or not the condensation slip will possibly occur is predicted by the conveyance of the first sheet of recording medium. Therefore, the problem that the condensation slip causes the image forming apparatus 100 to output defective images can be prevented by minimally extending the recording medium interval.

In this embodiment, the material for the film 22 was polyamide. However, this embodiment is not intended to limit the present invention in terms of the material for the film 22. That is, it does not matter whether the material for the film 22 is SUS or thermally conductive resin, as long as the fixing device 103 is configured so that as the fixing device 103 changes in the state of its film 22 in terms of rotation, the temperature detected by the thermistor 25 and the set temperature become different from each other. Further, the film heating means of the fixing device 103 was the heater 23. However, as long as the fixing device 103 is configured so that as the film 22 changes in its state of rotation, the temperature detected by the thermistor 25 becomes different from the set temperature, the same effects as those obtained by this embodiment can be obtained. These apply to the following embodiments as well.

### Embodiment 2

### Description of Image Forming Apparatus

The image forming apparatus 100 in this embodiment has a printing ratio detecting means which detects the printing ratio of an image (image pattern) formed on a sheet P of recording medium. Except that the image forming apparatus 100 in this embodiment is capable of detecting the printing ratio, the fixing developing device 3 and image forming apparatus 100 in this embodiment are the same in structure as those in the first embodiment. The image forming apparatus 100 in this embodiment is characterized in that whether the first or second mode is to be selected is determined based on the printing ratio of the image pattern, ambient temperature, and ambient humidity.

Whether or not the condensation slip occurs is influenced also by the printing ratio of the image pattern. The smaller the printing ratio, the less likely is the condensation slip to occur, and the higher the printing ratio, the more likely is the condensation slip to occur, for the following reason. That is, in a case where the image bearing surface of a sheet P of recording medium is entirely covered with toner, the moisture in the sheet P is prevented from evaporating out of the sheet P from the image bearing surface. In this case, therefore, the image-free surface side of the sheet P, that is, the pressure roller side of the sheet P, increases in the amount of water vapor. Therefore, the more likely it is to the pressure roller 24 that the moisture condensation occurs.

The relationship between the ambient temperature and humidity with regard to the occurrence of the condensation slip is shown in FIGS. 10, 11 and 12. Referring to FIG. 10, the area in which the condensation slip occurs, corresponds to a case in which the recording medium are sheets P of recording paper, which were left unattended for a substantial length of time after the unsealing of the package in which they were, and the printing ratio was 100%, that is, the image bearing surface of each sheet P was entirely covered with toner, as described above. The area of FIG. 11, which corresponds to the occurrence of the condensation slip, corresponds to a case in which sheets P of recording paper, which were left unattended for a substantial length of time after the unsealing of the package in which they were, and the printing ration was 50%, that is, 50% of the image bearing surface of each sheet P was covered with toner. The condensation slip occurrence area of FIG. 12 corresponds to a case in which sheets P of recording paper which were left unattended for a substantial length of time after the unsealing of the package in which they were, were used as recording medium, and the printing ratio was 10%, that is, 10% of the image bearing surface of each sheet P was covered with toner.

Referring to FIGS. 10, 11 and 12, Zone A corresponds to nonoccurrence of the discharge screw 9, and zone B corresponds to possible occurrence of the condensation slip. The lower the printing ratio, the greater, the Zone A. That is, the lower the printing ratio, the less likely it is for the condensation slip to occur.

### <Description of Control Sequence>

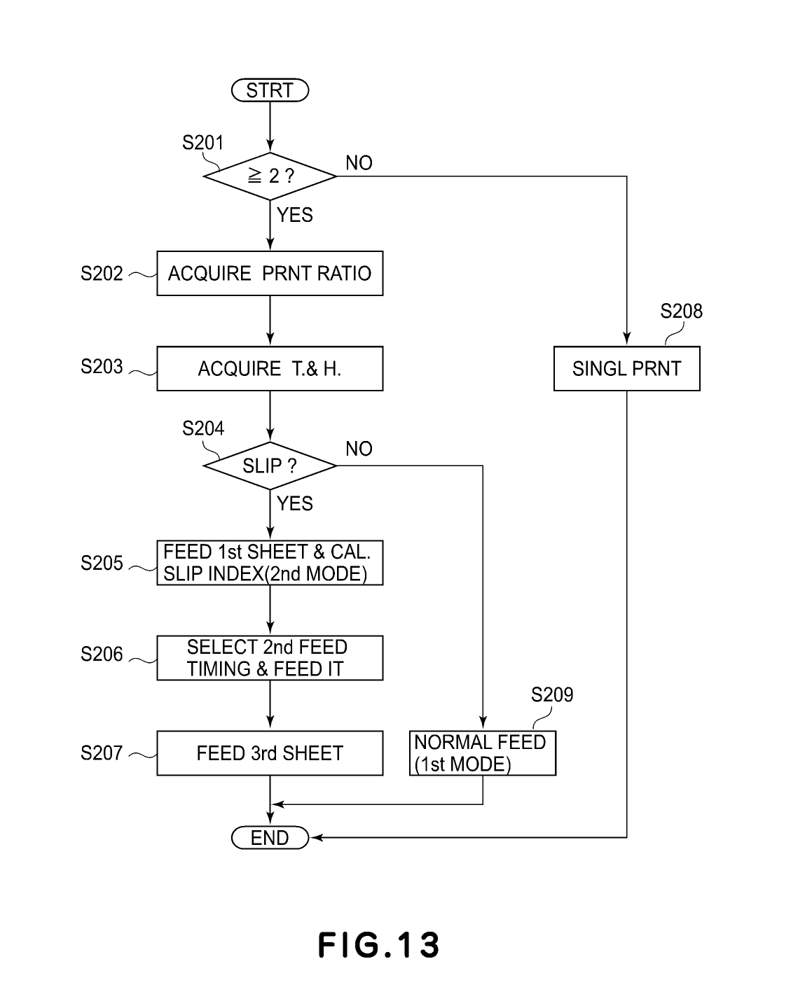

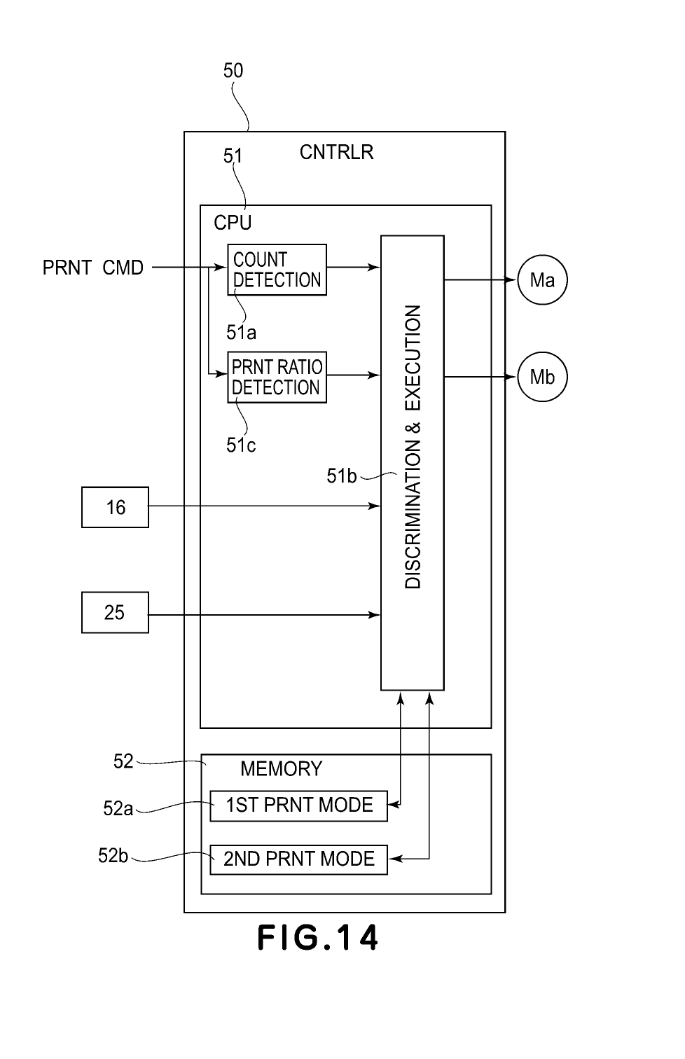

FIG. 13 is a flowchart of the control sequence, in this embodiment, for preventing the condensation slip. FIG. 14 is a block diagram of the control system (hardware) which executes the control sequence.

The determining-executing section 51b of the controlling section 51 determines whether or not the inputted image formation job is a continuous printing job which requires two or more prints to be consecutively outputted, based on the print count which the print count detecting section 51a obtained from the print count information in a print command (S201). If the job requires only one print (N), CPU 51 proceeds to S208, in which outputs one prints, and ends the printing operation. If the job requires two or more prints to be consecutively outputted (continuous printing job) (Y), it proceeds to S202.

In S202, the CPU 51 takes in the printing ratio of the image pattern, which the printing ratio detecting section 51c (printing ratio detecting means) detects from the image information of the first sheet in a print command. In S203, the determining-executing section 51b takes in the temperature-humidity combination detected by the temperature-humidity sensor 16.

In S204, the determining-executing section 51b determines whether or not there is a possibility that the temperature-humidity combination will cause the condensation slip. In a case where the printing ratio is no less than 50%, determining-executing section 51b uses FIG. 10, whereas in a case where the printing ratio is no less than 10%, it uses FIG. 11. Further, in a case where the printing ratio is no more than 10%, the determining-executing section 51b uses FIG. 12. If there is no possibility that the condensation slip will occur (N), the determining-executing section 51b proceeds to S209, in which it causes the image forming apparatus 100 to operate in the first printing mode 52a, whereas if there is a possibility that the condensation slip will occur (Y), it proceeds to S205.

In S205, the sheets P of recording medium are continuously conveyed in the second printing mode 52b. As soon as the first sheet P completely comes out of the nip N, the determining-executing section 51b calculates the slip index to determine whether or not there is a possibility that the condensation slip will occur, based on how the film 22 rotates in the recording medium interval. In S206, it determines the proper conveyance timing for the second sheet P, based on the slip index calculated in S205, and conveys the second sheet P. Then, it proceeds to S207, in which it begins to convey the third sheet P and the sheets P thereafter, with the same recording medium as that in the first printing mode.

### <Results of Verification Tests>

The effectiveness of the condensation slip preventing method in this embodiment were verified by conveying sheets P of recording medium under two ambiences (first and second ambiences) which are different in the temperature-humidity combination. The first temperature-humidity-combination was 23° C./50%, and the second temperature-humidity combination was 23° C./80%. In the first ambience (23° C./50%) which corresponds to Zone A, in which the condensation slip does not occur. The second ambiance (23° C./80%) which corresponds to Zone B, in which the condensation slip possibly occurs. The sheets P of recording medium used for the verification tests were CS-680 (product of Canon Marketing Japan). The printing speed was set to 20 ppm.

As for the condition of the sheets P, two sets of sheets of sheets P, which are different in moisture content were used. One set of sheets P was used immediately after the package in which the sheets P were contained was unsealed. The other set of sheets P were used after being left unattended for a substantial length of time after the package in which they were contained was unsealed. Regarding the printing ratio, two images which were different in printing ratio were used. One image was a text image, and was 5% in printing ratio. The other image was 100% in printing ratio; it covered the entirety of the image bearing surface of each sheet P with toner. Table 3 shows the results of the verification tests.

TABLE 3

| | | | | | | | Image |
|---|---|---|---|---|---|---|---|
| Temp. | | | Print | | | Delay | defects |
| (deg. | Humid. | States of | ratio | | Slip | Time | by dew |
| C.) | (%) | Sheets | (%) | Modes | Index | (sec) | slip |
| 23 | 50 | Just after | 5 | 1^{st} | — | 0 | No |
| | | unsealed | | | | | |
| 23 | 50 | Just after | 100 | 1^{st} | — | 0 | No |
| | | unsealed | | | | | |
| 23 | 50 | Left unused | 5 | 1^{st} | — | 0 | No |
| | | after | | | | | |
| | | unsealed | | | | | |
| 23 | 50 | Left unused | 100 | 1^{st} | — | 0 | No |
| | | after | | | | | |
| | | unsealed | | | | | |
| 23 | 80 | Just after | 5 | 1^{st} | — | 0 | No |
| | | unsealed | | | | | |
| 23 | 80 | Just after | 100 | 2^{nd} | 0 | 0 | No |
| | | unsealed | | | | | |
| 23 | 80 | Left unused | 5 | 1^{st} | 1 | 0 | No |
| | | after | | | | | |
| | | unsealed | | | | | |
| 23 | 80 | Left unused | 100 | 2^{nd} | 5 | 2 | No |
| | | after | | | | | |
| | | unsealed | | | | | |

When the ambient temperature and humidity were 23° C. and 50%, respectively, the first printing mode was selected, and the condensation slip did not occur. When the ambient temperature and humidity were 23° C. and 80%, respectively, the first printing mode was selected for the image forming operation which was 5% in printing ratio, and the condensation slip did not occur.

When the ambient temperature and humidity were 23° C. and 80%, respectively, and the image forming operation which was 100% in printing ratio, the second printing mode was selected. In the case of the sheets P of recording medium which were used immediately after the unsealing of the package in which they were contained, the slip ratio was 0 whether the printing ratio was 100% or 5%. Therefore, the recording medium interval was not extended, and the condensation slip did not occur. In the case of the sheets P which were left unattended after the unsealing of the package in which they were contained, the slip index was 1 when the image was 5% in printing ratio, and therefore, the conveyance start timing was not delayed. The condensation slip did not occur. In the case where the printing ratio was 100%, the slip index was 5, and therefore, the conveyance start timing was delayed by two seconds. The condensation slip did not occur.

As described above, whether the first or second printing mode is to be selected is determined based on the printing ratio of the image (pattern) to be formed, and the detected temperature-humidity combination. Then, the conveyance timing for the second sheet P is adjusted based on the slip index which is calculated in a case where the second printing mode is selected. By controlling the image forming apparatus 100 as described above, it becomes possible to determine whether or not the condensation slip will occur, and therefore, it becomes possible to prevent the recording medium conveyance interval from being unnecessarily extended, and/or the conveyance start timing from being unnecessary delayed. Further, by detecting the printing ratio of the image (pattern), it is possible to more precisely control the image forming apparatus 100 than in the first embodiment.

### Embodiment 3

### Description of Image Forming Apparatus

The image forming apparatus 100 in this embodiment is characterized in that whether or not the condensation slip will occur is predicted by monitoring the changes which occur to the slip index which is obtained as each sheet P of recording medium is moved through the nip N while the sheets P are conveyed in the normal printing mode. By predicting the occurrence or nonoccurrence of the condensation slip as described above, it becomes possible to determine whether or not the condensation slip will occur, based on only the result of the actual introduction of the sheets P of recording medium into the fixing device 103, instead of relying on the detection of the ambience and printing ratio. Therefore, it becomes possible to delay the conveyance timing (altering conveyance interval) only when there is a possibility that the condensation slip will occur. This embodiment is also applicable to an image forming apparatus which dos not have a temperature-humidity combination detecting means and/or printing ratio detecting means. <Description of Control Sequence>

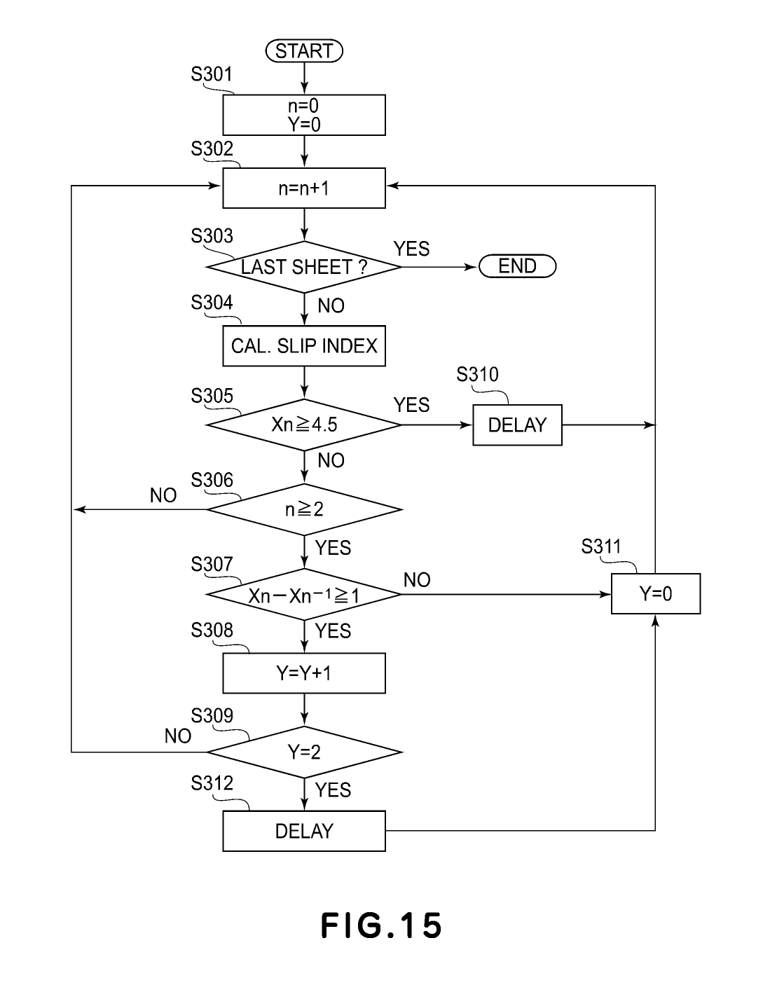

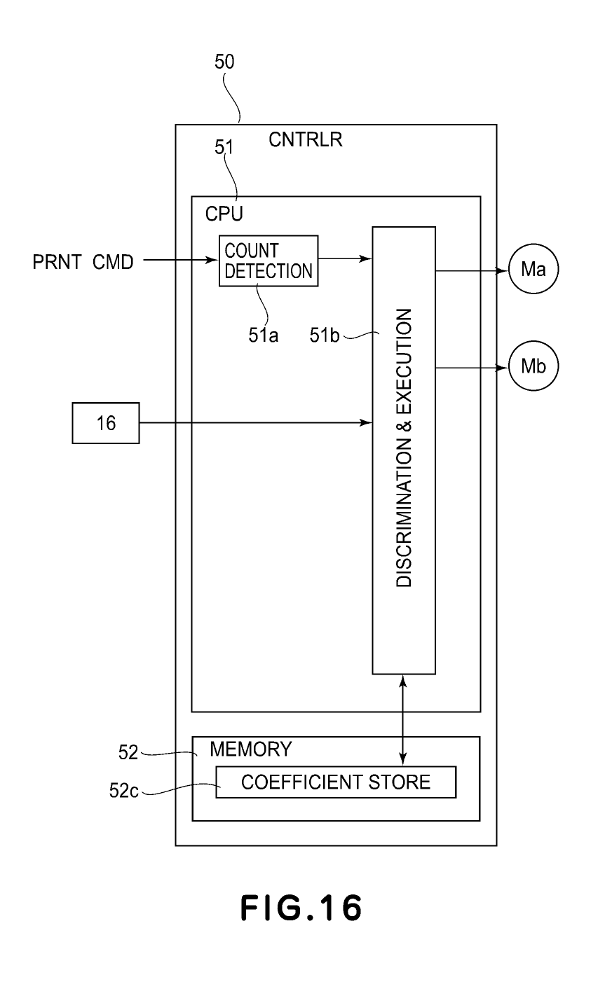

FIG. 15 is a flowchart of the control sequence, in this embodiment, for preventing the condensation slip. FIG. 16 is a block diagram of the control system (hardware) which executes the control sequence. The control sequence in this embodiment is such that if the slip index consecutively increases twice or more by 1, the conveyance timing is delayed. The control sequence in this embodiment may be used in combination with those in the first and second embodiments.

The determining-executing section 51b of the CPU 51 resets the coefficient used for control (S301). “n” stands for the coefficient which shows the ordinal number of sheet P of recording medium in the continuous image formation job. “Y” stands for the coefficient which is counted up if the slip index consecutively increases by one or more. The coefficient n is stored in the coefficient storage 52c of the memory 52.

In S302, the print count detected by the print count detecting section 51a from the print count information in a print command. If the sheet P which is going to be conveyed is the first one, the coefficient n is one (n=1). In S303, the determining-executing section 51b determines whether or not the printing job is at its end (sheet P is the last one or not). If the n-th sheet P is the last one (Y), the determining-executing section 51b ends the image forming operation. If not (N), it proceeds to S304.

In S304, the determining-executing section 51b calculates the slip index Xn after the passage of the n-th sheet P through the nip N. In S305, it evaluates the absolute value of the slip index Xn. Regarding the verification test condition, in this embodiment, it has been found in advance that if the slip index is no less than 4.5, it is possible that the image forming apparatus 100 will output images which suffer from defects attributable to scuffing. Thus, if the slip index Xn is no less than 4.5 (Y), the determining-executing section 51b proceeds to S310, in which it immediately delays the conveyance start timing. With the use of this controlling method, even if the slip index suddenly, or gradually, increases, it is possible to prevent the occurrence of the condensation slip. If the slip index Xn is no more than 4.5 (N), the determining-executing section 51b proceeds to S306.

In S306, if the sheet P is the first one, the determining-executing section 51b returns to S302 so that it can calculate the slip index for the second sheet P, and calculates the slip index of the second sheet P. If the ordinal number of the sheet P is second or higher (Y), it proceeds to S307. If the ordinal number of the sheet P is less than the second (N), it returns to S302. In S307, the determining-executing section 51b compares the current slip index Xn with the immediately preceding slip index Xn−1. If the current slip index is greater by one or more compared to the slip index of the immediately preceding sheet P (Y), the determining-executing section 51b proceeds to S308, in which it increases Y. If the amount by which the slip index has increased is less than one (N), the determining-executing section 51b proceeds to S311, in which it resets Y, and returns to S302.

In S309, the determining-executing section 51b determines whether or not the slip index Xn has consecutively increased two or more times by one or more, based on the value of Y. If the slip index has increased only once (N), the determining-executing section 51b returns to S302. If the slip index has increased twice (Y), the determining-executing section 51b proceeds to S312, in which it determines that the condensation slip will possibly occur, and delays the conveyance timing for the second sheets P and the sheets P thereafter. Thereafter, the determining-executing section 51b continues to calculate the slip index Xn during every recording medium interval until the job is completed.

### <Results of Verification Tests>

The effectiveness of this embodiment was verified by outputting images which were 100% in printing ratio, at a printing speed of 18.5 ppm, in an ambience, the temperature-humidity combination of which was 23° C./80%. The recording medium was CS-680 (product of Canon Marketing Japan).

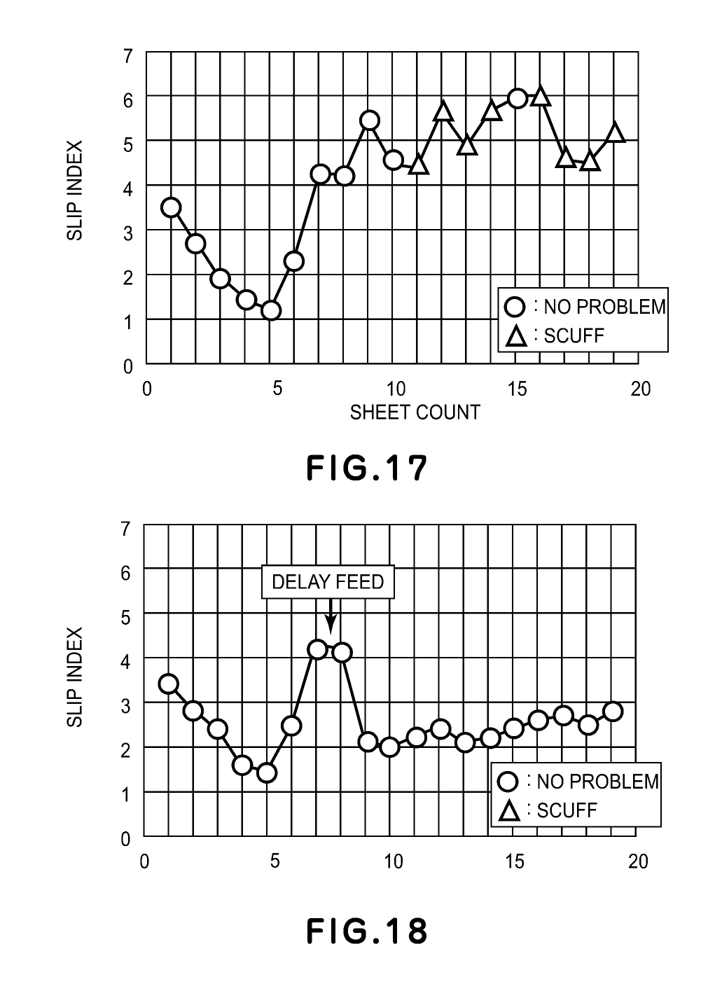

FIG. 17 shows the relationship which occurred among the slip index in every recording medium interval, sheet counts, and whether or not the image forming apparatus 100 outputted images which suffered from the defects attributable to scuffing, when the control method in this embodiment was not used. According to the results of this verification test, the slip index consecutively increased by a substantial amount during the recording medium interval between the fifth and sixth sheets P, and the recording medium interval between the sixth and seventh sheets P. Then, the scuffing occurred to the images on the eleventh sheet P and the sheets P thereafter.

In comparison, FIG. 18 shows the relationship which occurred among the slip index in every recording medium interval, sheet counts, and whether or not the image forming apparatus 100 outputted images which suffered from the defects attributable to scuffing, when the control method in this embodiment was used. In the case of this verification test, the slip index increased by one or more during the interval between the fifth and sixth sheets P, and the interval between the sixth and seventh sheets P. Thus, the occurrence of the condensation slip was prevented by delaying the conveyance timing for the eighth sheet P and sheets P thereafter by two seconds.

### Embodiment 4

### Description of Image Forming Apparatus

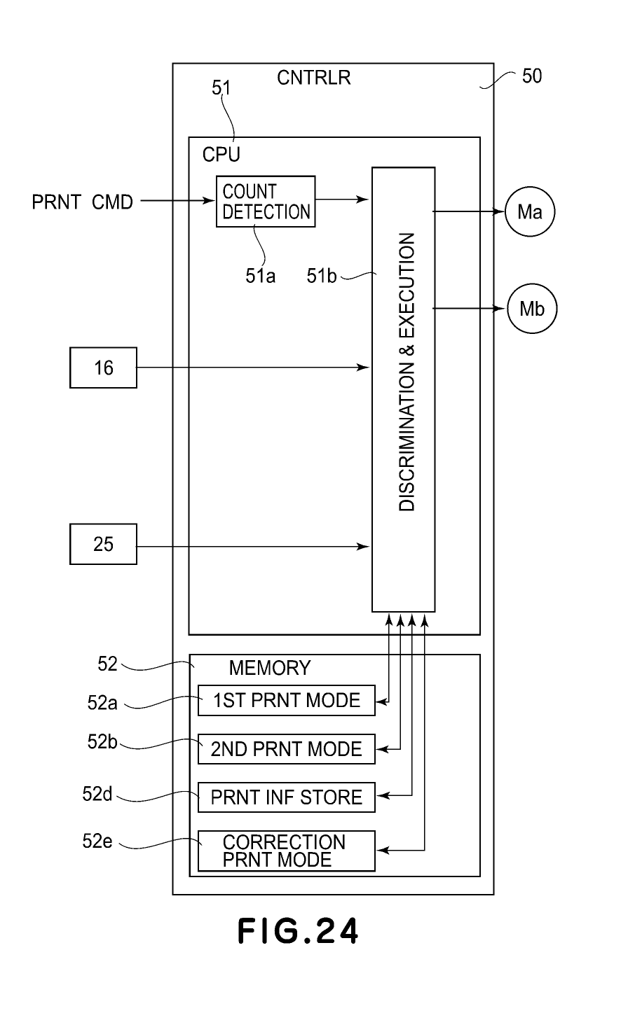

The image forming apparatus 100 in this embodiment is different from those in the first to third embodiment. It is characterized in that not only the changes in the slip index is monitored during recording medium intervals, but also, they are stored in the memory 52 and are used to set the conveyance timing for the conveyance of the next sheet P. That is, in the first to third embodiments, the slip index was monitored, and was used to adjust the recording medium conveyance timing. In this embodiment, whether or not the adjustment was proper is determined, and the results of the determination are used to more properly set the conveyance timing for the next sheet P. The information regarding the initial temperature of the thermistor 25, slip index measured during a printing operation, ambience (temperature, humidity, etc.), recording medium conveyance start timing, printing mode, etc., is stored in the printing information storage 52d (printing information storing means) of the memory 52 (FIG. 24).

This embodiment is described about only its differences from the first embodiment. In this embodiment, “recording medium interval extension slip index”, which is expressed in the form of a mathematical formula (2), is used in addition to the slip index which was used in the preceding embodiments, and is expressible in the form of the mathematical formula (1).

∫ₜ₃^{t4}ΔTdt (2)

Like the slip index, the recording medium interval extension slip index also is a value obtained by integrating the difference between the set temperature and thermistor temperature. However, the recording medium interval extension slip index slip index is different from the slip index in the range of integration. This recording medium interval extension slip index is such a slip index that is obtained immediately before the second sheet P of recording medium reaches the nip N in a case where the conveyance timing for the second sheet is delayed in the second printing mode. That is, the integration ending time t4 in Mathematical Formula (2) is the point in time at which the second sheet P arrives at the nip N. The integration start time t3 is the point in time which is earlier than the integration ending time t4 by a value equal to the recording medium interval in the first printing mode (=t2-t1).

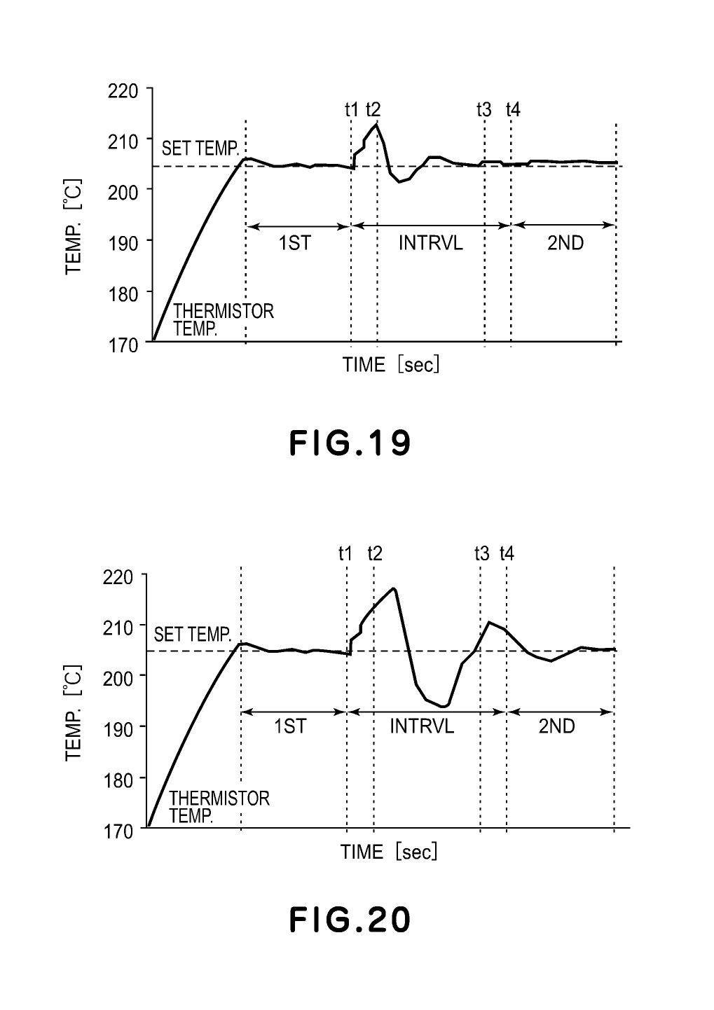

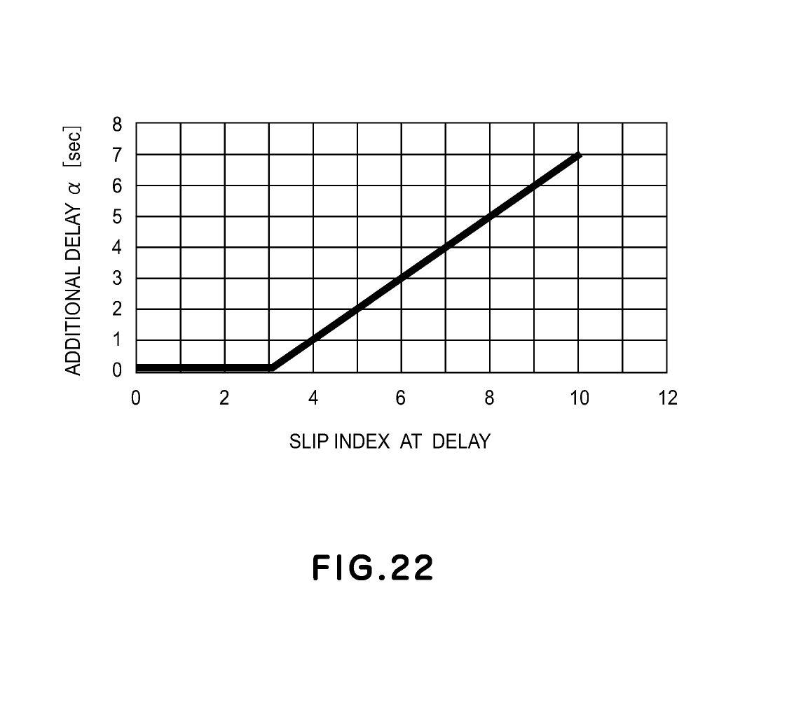

Here, FIGS. 19 and 20 show the changes which occurred to two thermistor temperatures when the conveyance timing for the second sheet P was delayed in the second mode, in the control sequence in the first embodiment. FIG. 22 shows the relationship between the length by which the recording medium interval was extended, and the length of time by which the recording medium conveyance timing was delayed.

FIG. 19 shows that after the first sheet P came out of the nip N, the rotational speed of the film 22 suddenly dropped because of the occurrence of the condensation slip. According to FIG. 19, however, while the conveyance timing for the second sheet P was delayed, the pressure roller 24 was cleared of the condensation, and therefore, the rotational speed of the film 22 recovered to the normal one by the time the second sheet P reached the nip N. Therefore, immediately before the second sheet P reached the nip N, the difference between the set temperature and thermistor temperature had reduced. Thus, the recording medium extension slip index, which is expressible in the form of Mathematical Formula (2) was 2.5.

FIG. 20 shows that after the first sheet P came out of the nip N, the rotational speed of the film 22 suddenly dropped because of the occurrence of the condensation slip. FIG. 20, however, is different from FIG. 19 in that the pressure roller 24 was not cleared of all the condensation while the conveyance timing for the second sheet P was delayed, and therefore, the rotation speed of the film 22 did not fully recover to the normal one by the time second sheet P reached the nip N. Therefore, immediately before the second sheet P arrived at the nip N, the difference between the set temperature and thermistor temperature had become substantial. Thus, the recording medium conveyance extension slip index, which is expressible in the form of Mathematical Formula (2), was 3.8.

This value is prohibitively large to determine that there is no possibility that the condensation slip occurs. That is, it indicates that in order to ensure that the condensation slip will not occur, the conveyance timing for the second sheet P has to be further delayed.

In the first embodiment, the risk of the occurrence of the condensation slip in a typical ambience is grasped in advance, and the conveyance timing for the second sheet P was control based on the risk. Therefore, in a case where the recording medium used for a given job is substantially different from the typical recording medium, in a case where the recording medium has substantially changed in condition because it was stored under an unusual condition, or in the like case, it is possible that a situation such as the one shown by FIG. 20 will occur, although the occurrence will be rare.

In this embodiment, such control is executed to further reduce the possibility that the condensation slip will occur, even in a situation such as the above described. In this embodiment, therefore, to begin with, the conveyance timing for the second sheet P is adjusted based on the preceding verification, with the use of the control sequence similar to that used in the first embodiment.

Then, in order to determine whether or not the control used in the first embodiment was satisfactory to prevent the condensation slip, the recording medium extension slip index, which is expressible in the form of Mathematical Formula (2) is calculated, and the obtained index is stored in the storing section 52d along with the various conditions under which sheets P are conveyed. Then, if recording medium is conveyed under a condition which is similar to one of those stored in the storing section 52d, the stored information is referred to, in order to convey the second sheet P with more proper timing. Therefore, it is possible to more reliably prevent the condensation slip.

However, it is possible that unlike the scenario described above, the conveyance timing for the second sheet P is delayed longer than the actual length of time by which the timing needs to be delayed, and therefore, the image forming apparatus is unnecessarily reduced in productivity. More concretely, in the case of the above described timing chart in FIG. 7(B) in the first embodiment (second printing mode was selected, but it was determined that there is no possibility that the condensation slip will occur), the timing with which the second sheet P is conveyed is delayed unnecessarily long. In this embodiment, in such a situation, the slip index, which is expressible in the form of Mathematical Formula (1) is stored, and if recording medium is conveyed under a similar condition, the first printing mode is selected in advance to prevent unnecessary reduction in productivity.

As described, in this embodiment, the slip index, which was obtained with the use of Mathematical Formula (1), and the recording medium interval extension slip index, that is, an additional slip index, expressible in the form of another Mathematical Formula (4), are calculated during the conveyance of a sheet P, and are stored. Then, the stored recording medium interval extension slip index is referred to, in order to ensure that the condensation slip is more reliably prevented during the following recording medium conveyance. Therefore, it is possible to increase productivity compared to the first embodiment.

### <Description of Control>

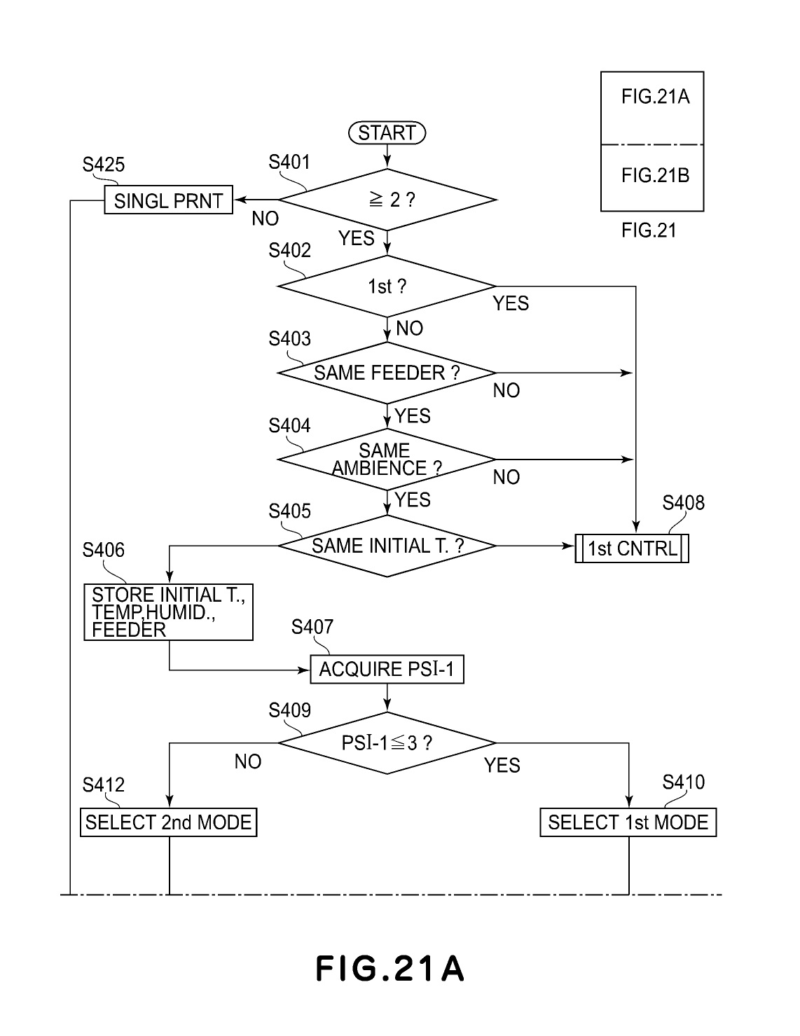

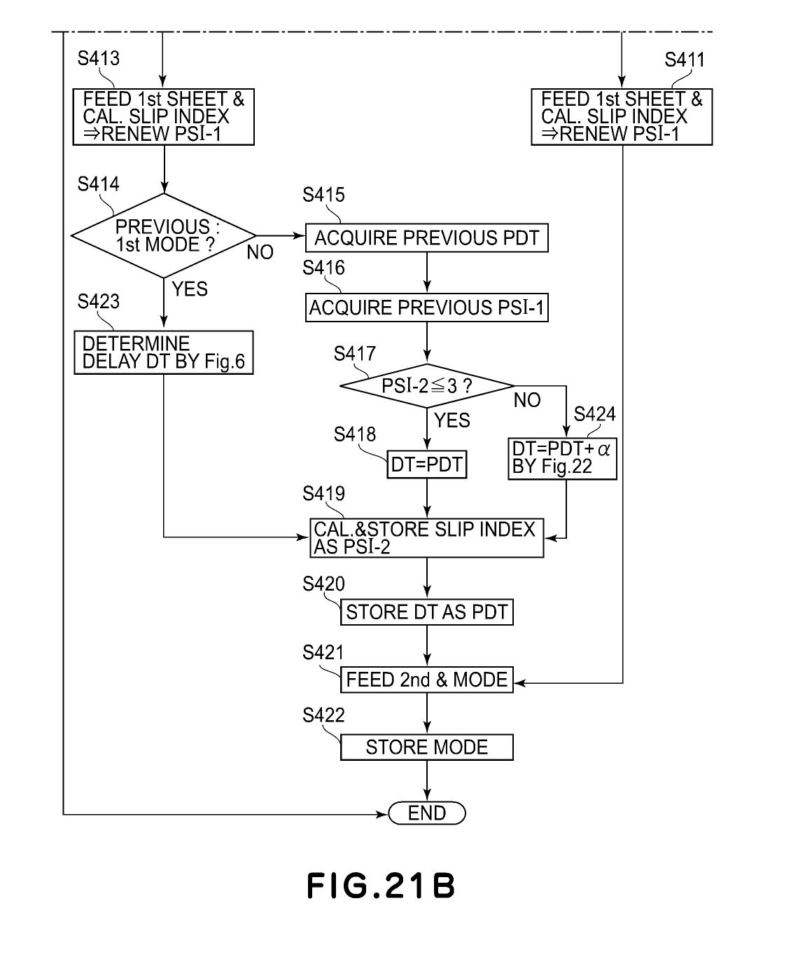

FIGS. 21A and 21B are a flowchart of the control sequence, in this embodiment, for preventing the condensation slip. FIG. 24 is a block diagram of the structure of the control system (hardware) which executes the control sequence. Referring to FIG. 24, the memory 52 in this embodiment has a print information storing section 52d and an adjustment printing mode 52e, in addition to those in the memory 52 in the preceding embodiments. In this embodiment, if a printing operation is carried out under a similar condition to the preceding printing operation, the control sequence carried out in the preceding printing operation, and the slip index obtained in the preceding printing operation, are referred to, in order to control the fixing device 103 based on the stored information.

The print count detecting section 52a of the CPU 51 determines the print count from the print count information in a print command (S401). If the print count is only one (N), the CPU 51 proceeds to S425, in which it causes the image forming apparatus 100 to output one print, and ends the printing operation.

The determining-executing section 51b of the CPU 51 determines whether or not the printing job requires two or more prints to be consecutively outputted, based on the print count which the print count detecting section 51a detected from the print count information in the print command (S401). If the job requires only one print to be outputted (N), the determining-executing section 51b proceeds to S425, in which it outputs one print, and ends the operation. If the job requires two or more prints to be consecutively outputted (H), the determining-executing section 51b determines, in S402-S405, whether or not the information regarding the preceding printing job can be used for the current job. Through S402-S405, it is confirmed that the current job can be done under the condition similar to that under which the preceding job was done.

In S402, immediately after the electric power source of the image forming apparatus 100 is turned on, it is determined whether or not two or more prints were consecutively outputted in one of the preceding printing jobs. If no job has been done (Y), the determining-executing section 51b carries out the initialization control sequence in S408. If the determining-executing section 51b determines that there was a printing job in which two or more prints were consecutively outputted (N), it proceeds to S403.

In S403, the determining-executing section 51b determines whether or not the cassette (5 or 15) from which sheets P are conveyed for the current printing job is the same as in the preceding job. If the cassette selected in the current job is different from the one selected in the preceding job (N), the determining-executing section 51b determines that the recording medium P used in the current job is different from the one used in the preceding job, and proceeds to S408, in which it executes the control sequence which is to be executed when the cassette used for the current job is different from the one used in the preceding job. Although the following control sequence is not used in this embodiment, if it is possible to obtain the information regarding which cassette was used, from the preceding job, this information can be used in combination with the information about the origin of the recording medium conveyance to more reliably determine whether or not sheets of recording medium which are the same in type as those used for the preceding image forming operation. If the determining-executing section 51b determines that the sheets P are the same as those used in the preceding job (Y), it proceeds to S404.

In S404, the determining-executing section 51b determines whether or not the temperature and humidity detected by the temperature-humidity sensor 16 are significantly different from those detected while the preceding job was done. If the difference between the temperature detected during the current job and that during the preceding job is no more than ±2° C., and the difference between the humidity detected during the current job and that in the preceding job is no more than ±5%, the determining-executing section 51b determines that the ambience in which the current job is being done is the same as that in which the preceding job is done (Y), and it proceeds to S405. If the determining-executing section 51b determines that the ambience has changed (N), it goes to S408, in which it carries out the initialization sequence.

In S405, the determining-executing section 51b determines whether or not the temperature detected by the thermistor is substantially different from the temperature detected at the beginning of the preceding job, in order to determine whether or not the temperature of the fixing device 103 (fixing section temperature) at the starting of the current job is roughly the same as that in the preceding job. That is, S405 is a step for determining whether or not the current job is the same as the preceding job in terms of the likelihood of occurrence of the condensation slip. For the sake of simplification of description, this embodiment is described with reference to a case where how warm the fixing device 103 is determined based on the temperature detected by the thermistor 25. However, information such as the print count of the preceding job, length of time having elapsed from the ending of the preceding job, etc., can also be used to determine how warm the fixing device 103 is.

In S405, if the difference between the temperature detected by the thermistor at the start of the current job and that in the preceding job is no more than ±20° C., the determining-executing section 51b determines that how warm the fixing device 103 (condition of fixing section in terms of temperature) is the same as that in the preceding job (Y), and it proceeds to S406. If it determines that the state of the fixing device 103 in terms of warmth is substantially different from that in the preceding job (N), it goes to S408, in which it carries out the initialization sequence.

As described above, if it is determined through S402-S405 that the information of the preceding job cannot be utilized for the current job, the initialization sequence is carried out in S408.

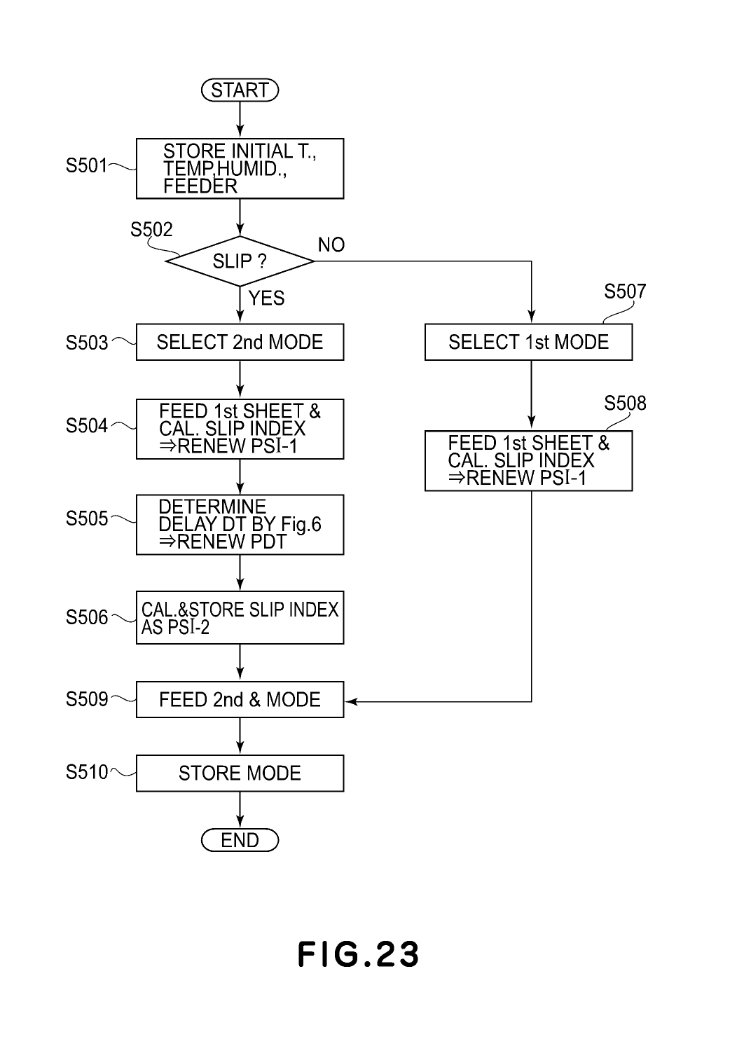

FIG. 23 is a flowchart of the initialization sequence to be carried out in S408. Basically, the initialization sequence in this embodiment is the is the same as the control sequence in the first embodiment, except that in the initialization sequence in this embodiment has steps through which information about ambient temperature and humidity, information about the origin of the sheets P in the apparatus main assembly 110, initial temperature of the thermistor 25, and information about the slip index or the like measured or calculated during a printing operation, in addition to the steps which the control sequence in the first embodiment has.

In S501, the determining-executing section 51b stores the temperature and humidity detected by the temperature-humidity sensor 16, initial temperature of the film 22 detected by the thermistor 25, origin of recording medium (from which of cassette 5 and tray 35 recording medium is delivered), and the like information.

In S502, the determining-executing section 51b determines whether or not the combination of the detected temperature and humidity will possibly cause the condensation slip. If the combination has no possibility of causing the condensation slip (N), the determining-executing section 51b selects the first printing mode, in which the two or more prints are consecutively outputted in the normal printing mode (S507). Then, as the first sheet P comes out of the nip N, the determining-executing section 51b calculates the slip index, and stores the value of the slip index, as a slip index PSI-1 which is referred to during the following printing operation, in the storing section 52d (S508), and proceeds to S509, in which it conveys the second sheet P with the normal timing.

If the determining-executing section 51b determines, in S502, that the combination of the measured temperature and humidity will possibly causes the condensation slip (Y), it selects the second printing mode, in which the conveyance timing for the second sheet P is set based on the slip index (S503). Also in the second printing mode, the determining-executing section 51b calculates slip index after the first sheet P comes out of the nip N, and store the calculated slip index, as a slip index PSI-1 which is referred to during the next printing operation, in the storing section 52d (S504).

Next, in S505, the determining-executing section 51b determines the conveyance start timing delay length DT for the second sheet P, based on the slip index which the determining-executing section 51b calculates during the current print job following the control sequence shown in FIG. 6 as in the first embodiment, and stored the value of the determined conveyance start timing delay length DT, as the conveyance start timing delay length PDT which is to be referred to during the next printing operation, in the storing section 52d. Then, it proceeds from S506 to S509, in which it conveys the second sheet P with the use of the conveyance start timing delay length DT determined in S505. During this process, the determining-executing section 51b calculates the recording medium interval extension slip index, that is, the slip index calculated immediately before the arrival of the second sheet P at the nip N, and stores the calculated value, as the recording medium interval extension slip index PSI-2, which is referred to during the next printing operation.

Regarding the control sequence carried out in S509 after the conveyance of the second sheet P, it remains the same whether the first or second mode is selected. That is, the third sheet P and the sheets P thereafter are conveyed with the same recording medium interval as that in the first printing mode regardless of printing mode selection. Then, in S510, the determining-executing section 51b stores the selected printing mode in the storing section 52d, and ends the printing operation.

At this time, referring back to FIGS. 21A and 21B, if the determining-executing section 51b determines, through Step S402-S405, that the current printing job is such that it can utilize the information regarding the preceding printing job (Y), it proceeds to S406.

In S406, the determining-executing section 51b stores such information as the temperature and humidity detected by the temperature-humidity sensor 16, initial temperature detected by the thermistor 25, origin of recording medium conveyance (from which of cassette 5 and tray 15 sheets P are conveyed), etc., in the storing section 52d, and proceeds to S407.

Through the steps in the control sequence, which follow Step 407, the determining-executing section 51b refers to the information of the preceding printing job, and controls the image forming apparatus 100 (fixing device 103) based on the information of the preceding printing job. In S407, the determining-executing section 51b obtains the slip index PSI-1, which was calculated and stored in the storing section 52d during the preceding printing job.

Then, in S409, the determining-executing section 51b determines whether or not the preceding slip index PSI-1 was such that it would possibly cause the condensation slip. Like in the first embodiment, if the value of the slip index was greater than 3 (N), the determining-executing section 51b recognizes that it was highly possible that the condensation slip would occur during the preceding printing operation, and determines that it is highly possible that the condensation slip will occur during the current printing job as it was in the preceding job. On the other hand, if the preceding slip index PSI-1 was no more than 3 (Y), the determining-executing section 51b recognizes that there preceding printing job was relatively low in terms of the possibility of occurrence of the condensation slip, and determines that like in the preceding printing job, the current printing job also is low in the possibility of occurrence of the condensation slip.

If the determining-executing section 51b determines in S409 that the current printing job is low in possibility of occurrence of the condensation slip (Y), it proceeds to S410, in which it selects the first printing mode. Then, after the first sheet comes out of the nip N, the determining-executing section 51b calculates the slip index, and stores the calculated value, as the preceding slip index PSI-1, which is referred to during the next printing job, in the storing section 52, replacing thereby the value in the storing section 52d (S411). Then, it conveys the second sheet with the normal conveyance timing (S421).

If the determining-executing section 51b determines in S409 that the possibility of occurrence of the condensation slip is high (N), it proceeds to S412, in which it selects the second printing mode which sets the conveyance timing for the second sheet, based on the slip index. Also in this second printing mode, first, the determining-executing section 51b calculates the slip index after the first sheet comes out of the nip N. Then, it stores the calculated value, as the preceding slip index PSI-1, which is referred to during the next printing job, in the storing section 52d, replacing the value therein (S413).

Then, the determining-executing section 51b proceeds to S414, in which it determines whether the preceding printing job is done in the first or second mode. If it determines that the preceding printing job was done in the first printing mode (Y), it determines that no adjustment was made during the preceding print job, and therefore, there is no data which can be referred to determine the conveyance timing in the current second printing mode. Thus, it proceeds to S423, in which it sets the conveyance start timing delay length DT, which is to be used for the current printing job, based on the slip index calculated during the current printing job, following the control sequence shown in FIG. 6 as in the first embodiment, and proceeds to S419.

On the other hand, if the determining-executing section 51b determines in S414 that the preceding printing job was not done in the first printing mode (N), it proceeds from S414 to S415, in which it obtains the conveyance start timing delay length PDT for the second sheet P, which was used in the preceding job, from the storing section 52d. Next, in S416, it obtains the recording medium interval extension duration slip index PSI-2, which was calculated immediately before the second sheet P was conveyed, with the use of the above described conveyance start time delay, during the preceding printing job, from the storing section 52d.

In S417, the determining-executing section 51b determines whether or not the value of the above described preceding recording medium interval extension slip index PSI-2 is such that it possibly will cause the condensation slip. More concretely, it determines whether or not the slip index PSI-2 is greater than three.

If the value of the preceding recording medium interval extension slip index PSI-2 is no more than three (Y), it means that the conveyance start delay length PDT used during the preceding printing job was large enough to prevent the second sheet P from being subjected to the condensation slip. Thus, the determining-executing section 51b proceeds to S418, in which it sets the conveyance start timing delay length DT for the second sheet P in the current printing job to the same value as that of the conveyance start timing delay length PDT for the preceding printing job.

On the other hand, if the determining-executing section 51b determines in S417 that the recording medium interval extension length slip index PSI-2 is no less that three (N), it means that the conveyance start timing delay length PDT used during the preceding printing job was not large enough to prevent the second sheet P from being subjected to the condensation slip. Therefore, the conveyance timing delay length DT for the second sheet P in the current printing job has to be longer than the preceding conveyance timing delay length PDT. In this case, the determining-executing section 51b proceeds to S424 in which it sets the conveyance timing delay length DT for the current printing job to the sum of the preceding conveyance start timing delay length PDT and the conveyance start timing delay adjustment length a, and proceeds to S419. Here, the conveyance start timing delay adjustment length a is such a value that is set based on the value of the preceding recording medium interval extension length slip index PSI-2. It is set according to the relationship between the conveyance start timing delay adjustment length a and recording medium interval extension length slip index, which the graph in FIG. 22 shows.

In S419, the determining-executing section 51b calculates the value of the recording medium interval extension length slip index, which is the slip index in the recording medium interval immediately before the arrival of the second sheet P at the nip N, and stores the obtained value, as the preceding recording medium interval extension length slip index PSI-2, which is referred to during the next printing job, in the storing section 52d to replace the value in the storing section 52d (adjustment printing mode).

In S420, the value of the conveyance timing delay length DT used for the current printing job is stored as the preceding conveyance timing delay length PDT, in the storing section 52d to replace the value in the storing section 52d. As described above, the conveyance timing delay length DT for the second sheet P is set, and the second sheet P is conveyed with the set timing (S421). After the conveyance of the second sheet P through the nip N, the third sheet P and sheets P thereafter are conveyed with the same interval as that in the first mode. Then, in S422, the determining-executing section 51b stores the selected mode in the storing section 52d, and ends the printing operation.

### <Results of Verification Tests>

The effectiveness of the condensation slip prevention control in this embodiment were verified with the use of tests in which sheets P of recording medium were conveyed under two ambiences which were different in the combination of temperature and humidity. An image forming operation in which the control in this embodiment and an image forming operation in which the control in the first embodiment was used as a comparative control were carried out. Then, both operations were examined regarding whether or not the condensation slip occurred.

Whether or not the condensation slip possibly occurs is determined by calculating the slip index immediately before the arrival of the second sheet P at the nip N. In addition, the printing modes, slip index calculated after the passage of the first sheet P through the nip N, and length of time by which the second sheet conveyance start timing was delayed, were also determined. In the case of the control in this embodiment, this information is automatically stored in the storing section 52d. Therefore, these information was referenced.

In the case of the control sequence in the first embodiment as a comparative control sequence, this information was not stored. Therefore, the temperature detected by the thermistor 25 during the printing operation, signals from the recording medium detection sensor (unshown), etc., were recorded, and the slip index, etc., were obtained by the calculation made based on this information.

Table 4 shows the results of the verification tests 4-1-4-3, comparative tests 4-1-4-5, which were different in printing condition (ambience, recording medium type).

TABLE 4

| | | | | | | | Delay | | |
|---|---|---|---|---|---|---|---|---|---|
| | Manufacturing | Printing | | Sheets | | Rotation | time | Risk | Occurrence |
| | methods | Conditions | Ambiences | tested | Modes | index | (sec) | index | of delay |
| Comp. 4-1 | Emb. 1 | (i) | P1 | A | 2^{nd} | 2.0 | 0.0 | 1.5 | Yes |
| Comp. 4-2 | Emb. 1 | (ii) | P1 | B | 2^{nd} | 3.5 | 0.5 | 1.8 | Yes |
| Comp. 4-3 | Emb. 1 | (iii) | P1 | C | 2^{nd} | 4.5 | 1.5 | 3.5 | Yes |
| Comp. 4-4 | Emb. 1 | (iv) | P2 | B | 1^{st} | 2.0 | — | (2.0) | No |
| Comp. 4-5 | Emb. 1 | (v) | P2 | C | 1^{st} | 4.0 | — | (4.0) | No |
| Emb. 4-1 | Emb. 4 | (i) | P1 | A | 1^{st} | 2.0 | — | (2.0) | No |
| Emb. 4-2 | Emb. 4 | (iii) | P1 | C | 2^{nd} | 4.5 | 2.0 | 2.5 | Yes |
| Emb. 4-3 | Emb. 4 | (v) | P2 | C | 2^{nd} | 4.0 | 1.0 | 2.5 | Yes |

Table 4 shows the relationship among the printing conditions (ambience, recording medium type), printing modes, index of state of rotation, length of conveyance start timing delay, risk index, and whether or not the timing with which an image is to be formed on the second sheet P was delayed.

The index which shows the state of rotation of the film 22 is a value which is equivalent to the slip index which is calculated after the passage of the first sheet P through the nip N. If this value exceeds three, there is a possibility that the condensation slip will occur, and therefore, it is necessary for the conveyance timing for the second sheet P to be delayed.

The length of delay is the length of time by which the conveyance start timing for the second sheet P was delayed. The table shows the length of time (in second) by which the conveyance start timing for the second sheet P was delayed by the execution of the control sequence.

The risk index is such an index that indicates how high the possibility of the occurrence of the condensation slip to the second sheet P. It is equivalent to the slip index calculated immediately before the arrival of the second sheet P at the nip N. If this value is no less than 3, it means that the film 22 is not normally rotating at the time of the arrival of the second sheet P at the nip N, and therefore, the second print was outputted under the condition that the possibility of the occurrence of the condensation slip was high.

In addition, the table shows whether or not the timing with which an image is to be formed on the second sheet P was delayed by the control sequence. Except for the printing operation for which the first printing mode was selected, the delay occurred (because in the second printing mode, the delay occurs even if the length of delay is zero second).

By the way, in the case of the verification tests 4-1-4-3, the data regarding the cases in which the condition under which images were printed on the second sheet and sheets was the same as that in the preceding printing operation, are listed.

The verification tests were carried out under two ambiences which were different in both temperature and humidity. One of the two ambiences was 30° C. in temperature, and 80% in humidity (P1 in Table 4), and the other was 25° C. in temperature and 50% in humidity (P2 in Table 4).

As for the recording medium type, two types of recording medium were used. One is CS-680 (product of Canon Marketing Japan), and the other was GF-600 (product of Canon Marketing Japan). As for the recording medium condition, the recording mediums were used under three different conditions. Recording paper A was CS-680, and was used right after it was unpackaged. Recording paper B was also CS-680, but was left unattended for two days, in the same ambience as the one in which the printing tests were carried out, after it was unpackaged. Recording paper C was GF-600, which was left unattended for two days in the same ambience as the one in which the verification tests were carried out. If printing operations are the same in ambience and an image, the operation which uses the recording paper C is highest in the probability of the occurrence of the condensation slip, and the operations which use the recording papers B and A are middle and lowest.

There are five combinations of ambience and recording medium type, which are referred to as printing conditions (i)-(v). The images were 100% in printing ratio. That is, the entirety of each sheet P was covered with toner.

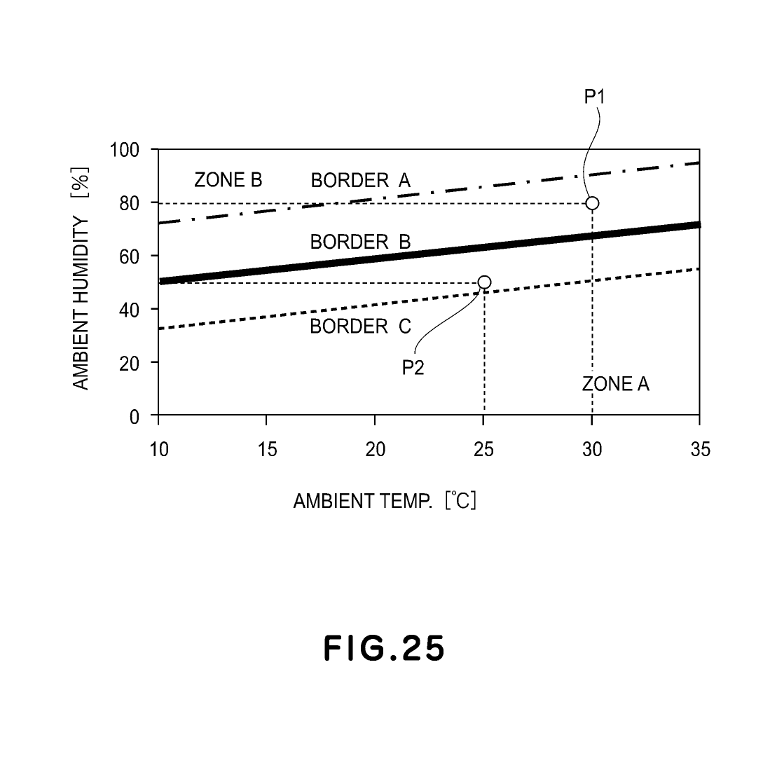

FIG. 25 shows the ambience, in terms of temperature-humidity combination, in which the condensation slip occurs when the images to be formed is 100% in printing ratio. FIG. 25 shows also the ambiences P1 and P2 shown in Table 4. In the case of FIG. 25, Zone A corresponds to the ambience which does not cause the condensation slip, whereas Zone B corresponds to the ambiences which possibly cause the condensation slip.

FIG. 25 has borderlines A, B and C, which partition FIG. 25. These borderlines correspond to the combinations A, B and C between the recording paper type and ambience. That is, in a case where an image which is 100% in printing ratio is formed on the test paper B, that is, in a case where the entirety of the image bearing surface of each test paper B is covered with toner, the top side of the borderline B is Zone B, and the bottom side of the borderline B is Zone A.

The contents of Table 4 were evaluated in consideration of the above described factors. Rows named Comparative examples 4-1-4-3 show the results of the printing operations controlled by the controlling method in the first embodiment.

In the first embodiment, in a case where an image which is 100% in printing ratio was formed on a sheet P of recording paper after the sheet P was left unattended for a substantial length of time after being unpacked, printing mode was selected based on whether or not the ambience is such that it possibly causes the condensation slip. Zones A and B in the first embodiment were shown in FIG. 10. The borderline in FIG. 10 is equivalent to the borderline B in FIG. 25. That is, the sheet P of recording medium used in the first embodiment is the same as the above described test sheet B.

The moisture content of a sheet P of recording paper is affected by the length of time the sheet P is left unattended after being unpackaged. Therefore, even if two sheets of paper are the same in type and ambience, it is possible that the two sheets P may be different in the possibility of occurrence of the condensation slip. In reality, therefore, the position of the border line between Zones A and B is variously affected by the length of time the sheet P of recording paper is left unattended. However, it is virtually impossible to determine how long a sheet P of recording paper has been left unattended. Therefore, it is realistic to set the border line between Zones A and B, based on the possibility with which the condensation slip will occur to a sheet P of recording medium after the sheet P was left unattended for a preset length of time in a preset ambience.

In the first embodiment, the above-mentioned preset length of time was two days, which is the same as the length of time the test paper B was left unattended. Therefore, the borderline in the borderline B in FIG. 25 is equivalent to the borderline in the first embodiment. Thus, referring to FIG. 25, the verification tests 4-1-4-3, and comparative tests 4-1-4-5 are described.

A test environment P1, which corresponds to comparative test 4-1, is above the borderline B. Thus, it belongs to Zone B. Therefore, the second printing mode is selected, and the state of rotation index is measured. However, the test sheet A is used.

Therefore, the result of the measurement is 2.0, and therefore, it does not occur that the conveyance timing for the second sheet P is delayed. However, a certain amount of time is necessary to measure the slip index (state of rotation index), etc. Therefore, the conveyance timing for the second sheet P is delayed compared to the normal conveyance timing for the second sheet P as shown in FIG. 7(B) (Table 4 shows occurrence of delay).

In comparison, in the case of the verification test 4-1 which is the same in printing condition (i) as the comparative test 4-1, the above described condition can be predicted for the second sheet P and the sheets P thereafter, based on the information stored during the preceding printing operation. Therefore, the first printing mode is selected, and therefore, the occurrence of the condensation slip can be avoided with no delay in the conveyance of the second sheet P (“no” delay).

In comparative tests 4-2 and 4-4, the test sheet B, which is the same as that used in the first embodiment was used. Thus, the printing mode selection is properly done, and also, the length of time by which the conveyance start timing for the second sheet P is to be delay is properly set.

Next, in the case of comparative test 4-3, a test environment P1 is above the borderline B, and therefore, it belongs to Zone B. Thus, the second printing mode is selected, in which the state of rotation index is calculated. In this case, the state of rotation index was 4.5, and therefore, the length of delay was set to 1.5 seconds based on this value (4.5) of state of rotation index. Thus, the conveyance of the second sheet P was started with this delayed timing. However, in terms of the occurrence of the condensation slip, the test sheet C used in these tests is disadvantageous compared to the test sheet B, which is the same as the sheet used in the first embodiment. Thus, the risk index calculated immediately before the arrival of the second sheet P at the nip N was, 3.5, which is significantly greater than 3.0.

In comparison, in the case of the verification test 4-2 which is the same (iii) in the printing condition as the comparative test 4-3, the above described state of rotation of the film 22 can be predicted based on the information stored during the preceding printing operation, as long as the prediction is for the second sheet P and sheets P thereafter. Therefore, the second printing mode is selected. In this case, the length by which the second sheet conveyance start timing was to be delayed was set to 2.0 seconds, which was longer than that in the comparative test 4-3. As the result, the risk index calculated immediately before the arrival of the second sheet P at the nip N became 2.5, which was less than 3.0.

Next, in the case of comparative test 4-5, test environment P2 is below the borderline B, and therefore, it belongs to Zone A. Thus, the printing operation was carried out in the first printing mode. In this case, the state of rotation index was 4.0, which was greater than 3.0. However, the length by which the conveyance start timing for the second sheet P was not set. Therefore, the risk index became 4.0, being the same as the state of rotation index.

In comparison, in the case of the verification test 4-3 which was the same (v) in printing condition as the comparative test 4-5, the state of rotation of the film 22 was predictable from the information stored during the preceding printing operation. Thus, the second printing mode was selected, and the risk index calculated immediately before the arrival of the second sheet P at the nip N was 2.5, which was below the 3.0.

As described above, in this embodiment, the information obtained during the preceding printing operation was referred to. Therefore, not only was it possible to reduce the possibility of occurrence of the condensation slip even as an image forming operation is carried out under an unexpected condition, but also, it was possible to prevent the conveyance start timing for the second sheet P from being unnecessarily delayed. Also in this embodiment, whether or not the information about the preceding printing operation is to be referenced is determined based on the result of the comparison between the temperature and humidity of the environment in which the current printing operation is carried out, and the temperature detected by the thermistor 25, and those obtained during the preceding printing operation. As another method, the length of time by which the conveyance starting timing was delayed may be adjusted according to the amounts by which these variable have changed since the preceding printing operation.

In this embodiment, how warm (hot) the fixing device 103 is at the beginning of a printing operation was determined based on the temperature detected by the thermistor 25. As for another method, in a case where the fixing device 103 is provided with other temperature detecting means than the thermistor 25, such as a temperature sensor for detecting the temperature of the pressure roller 24, how warm (hot) the fixing device 103 is hot at the beginning of a printing operation may be determined with reference to the temperatures detected by other temperature detecting means.

The controlling method in this embodiment is based on the controlling method in the first embodiment. The control was optimized with reference to the information obtained during the preceding printing operation. However, the control in this embodiment may be used in combination with those in the second and third embodiments, by storing and referencing the result of the detection of the printing ratio, as the image condition for a continuous printing operation, and/or by storing and referencing the slip index obtained during the recording medium interval between the second and third sheets P, and the recording medium interval thereafter.

### Embodiment 5

### Description of Image Forming Apparatus

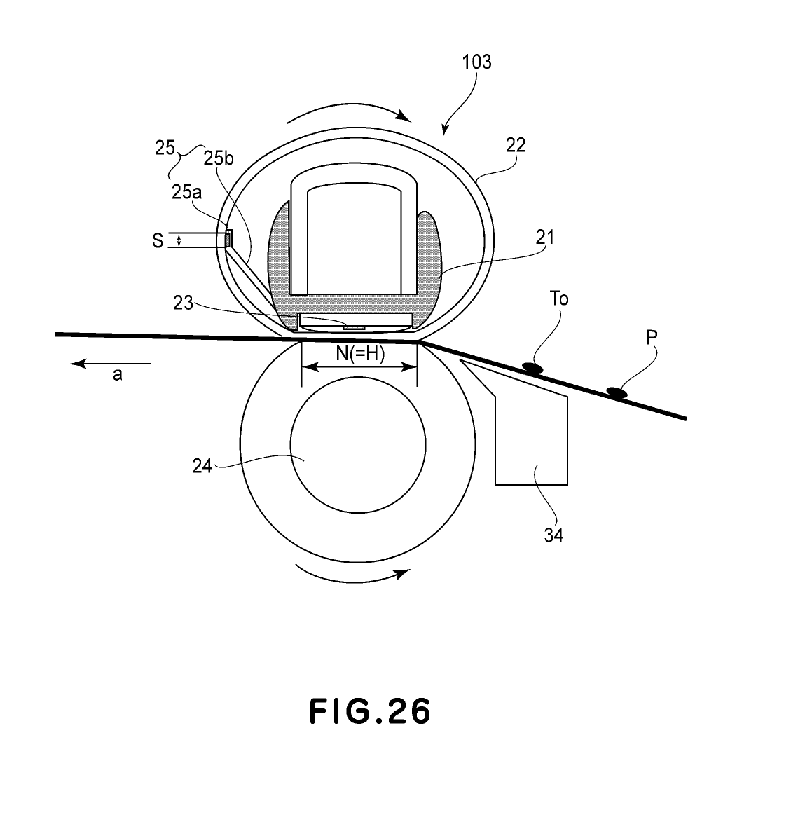

The image forming apparatus 100 in this embodiment is the same in structure as the image forming apparatus in the first embodiment, except that it has a fixing device 103 which is different from the fixing device 103 in the first embodiment in that in the case of the fixing device 103 in this embodiment, where the film 22 is heated is different from where the temperature of the film 22 is detected. FIG. 26 is a sectional view of the fixing device 103 in this embodiment. The difference of the fixing device 103 in this embodiment from the fixing device 103 in the first embodiment is described with reference to FIG. 26.

The thermistor 25 comprises a temperature sensing element 25a, and a flexible supporting member 25b. The thermistor 25 is disposed so that the supporting member 25b remains elastically deformed between the temperature sensing element 25a and stay 21. Thus, the temperature sensing element 25a is kept in contact with the film 22 by the resiliency of the supporting member 25b. Since the fixing device 103 is structured as described above, it is ensured that the temperature sensing element 25a remains in contact with the inward surface of the film 22. Therefore, the temperature of the film 22 can be reliably detected. The fixing device 103 is structured so that the temperature sensing element 25a detects the temperature of the film 22 in a temperature detection area S, which corresponds to the area of contact between the film 22 and temperature sensing element 25a.

However, a film heating area where the film 22 is heated by the heater 23 is the nip N. That is, in the case of the fixing device 103 in this embodiment, the film heating area where the film 22 is heated by the heater 23 is different from the temperature detection area S where the temperature of the film 22 is detected by the thermistor 25.

### <Explanation of Slip Index>

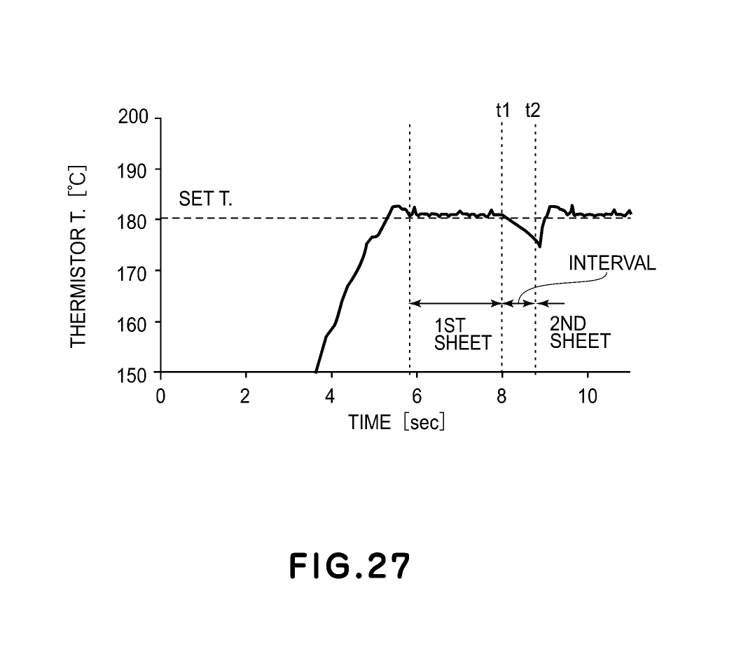

Next, the slip index used in this embodiment is explained. The fixing device 103 in this embodiment is different from the fixing device 103 in the first embodiment in the area where the temperature of the film 22 is detected by the thermistor 25, being therefore different in the changes which occur to the thermistor temperature, its absolute value, as the condensation slip occurs. FIG. 27 shows the relationship between the thermistor temperature and set temperature, which occurred when it was possible that the condensation slip would occur. In this embodiment, there is a certain amount of distance between the heater 22 and film temperature detection area S. Therefore, the target temperature is set to 180° C., which is lower than that in the first embodiment.

The temperature monitored by the thermistor 25 fell to 174° (lower than the set temperature) during the recording medium interval between the first and second sheets, and slightly overshot shortly after the second sheet P entered the nip N. Then, it became stable at the set temperature.

The reason why the thermistor temperature reduced during the recording medium interval between the first and second sheets is that the film 22 reduced in speed or stopped during the interval. As the film 22 suddenly reduce in speed while it is rotating at the normal speed, the heat which was being moved out of the nip N by the rotation of the film 22 fails to be moved out. Thus, the heat accumulates in the nip N. Thus, the portion of the film 22, which became stuck in the nip N, or the film heating area, increases in temperature, but, the portions of the film 22, which are outside the nip N, reduce in temperature because of heat transfer and heat radiation. Thus, the temperature detected by the thermistor 25 reduces during the recording medium interval.

As the temperature detected by the thermistor 25 reduces, and the difference between the thermistor temperature and set temperature becomes significantly large, the determining-executing section 51b increases the amount by which the heater 23 generates heat to increase the thermistor temperature to the set temperature. Thus, the portion of the film 22, which is stuck in the nip N, becomes higher in temperature than the set temperature. Thus, as the second sheet P begins to be conveyed, and the film 22 begins to rotate, the thermistor 25 detects the temperature overshoot, with such a timing that the thermistor 25 detects the temperature of the portion of the film 22, which were stuck in the nip N during the recording medium interval.

The amount of the above described temperature drop and overshoot of the film 22 is roughly proportional to the amount of the reduction in the speed of the film 22, and the length of time the film 22 remains stationary.

Next, the method for calculating the slip index is described. As in the first embodiment, the value of the integration of the difference between the set temperature and thermistor temperature is used as the slip index. The following is the mathematical formula for calculating the slip index.

∫ₜ₁^{t2}ΔTdt×1.2 (3)

Δ T stands for the amount of difference between the set temperature and the thermistor temperature; t1 stands for the point in time at which the first sheet P of recording medium comes out of the nip N; and t2 stands for the point in time at which the second sheet P of recording medium reaches the nip N in the first printing mode.

Referring to FIG. 26, when the film 22 is stationary and the thermistor temperature has substantially reduced, the slip index is relatively large. Unlike in the first embodiment, the area in which the temperature of the film 22 is detected in this embodiment is different from the area in which the film 22 is heated. Thus, based on the comparison, in terms of the structure and temperature change, between the fixing device 103 in the first embodiment and the fixing device 103 in the this embodiment, Mathematical Formula (3) was created by adding a coefficient of 1.2 to Mathematical Formula (1).

As the relationship between the slip index calculated with the use of Mathematical Formula 3 and the occurrence of the condensation slip was studied, it became evident that as long as the slip index was no more than three, the conveyance start timing did not need to be delayed, but, as the slip index exceeded three, the conveyance start timing needs to be delayed by the amount proportional to the amount of the increase in slip index, as it was in the first embodiment.

In the case of the image forming apparatus which uses the fixing device structured as described, and the above described slip index calculation formula, the control sequence shown in FIG. 8 was used as in the first embodiment, and the slip index was calculated based on the conveyance start timing delay length shown in FIG. 6. Further, the same condensation slip prevention method as that in the first embodiment was used. Then, the effectiveness of the fixing device structure in this embodiment upon the prevention of the occurrence of the condensation slip was verified.

### <Results of Verification Tests>

The effectiveness of this embodiment upon the prevention of the condensation slip was verified by carrying out verification tests which were different in the temperature-humidity combination and recording medium type. The verification test condition, recording medium type, throughput, state of recording medium P, and printing ratio were the same as those used in the verification tests for the first embodiment. Table 5 shows the results of the verification tests.

TABLE 5

| | | | | | | Image |
|---|---|---|---|---|---|---|
| Temp. | | | | | Delay | defects |
| (deg. | Humid. | States of | | Slip | Time | by dew |
| C.) | (%) | Sheets | Modes | Index | (sec) | slip |
| 23 | 50 | Just after | 1^{st} | — | — | No |
| | | unsealed | | | | |
| 23 | 50 | Left unused | 1^{st} | — | — | No |
| | | after | | | | |
| | | unsealed | | | | |
| 23 | 80 | Just after | 2^{nd} | 0 | 0 | No |
| | | unsealed | | | | |
| 23 | 80 | Left unused | 2^{nd} | 5 | 2 | No |
| | | after | | | | |
| | | unsealed | | | | |

The results obtained by the tests carried out to verify the effectiveness of this embodiment were the same as those obtained by the tests carried out to verify the effectiveness of the first embodiment. That is, in either case, the condensation slip did not occur. Further, even in the tests in which sheets P which were left unattended for a substantial length of time after being unpackaged were used as recording medium, the slip index was 5, which was the same as the slip index obtained by the verification tests for the first embodiment. Thus, as the conveyance start timing for the second sheet P was delayed by two seconds, the condensation slip did not occur.

As described above, in the case of the fixing device 103 in this embodiment, the temperature detection area S in which the temperature of the film 22 is detected was different from the film heating area in which the film 22 is heated by the heater 23. Also in the case of this fixing device 103, the changes which occurred to the state of rotation of the film 22 was detected by detecting the decrease in the temperature of the film 22 which occurred during the recording medium interval. Then, the amount by which the conveyance start timing is to be delay was determined based on the detected changes. Therefore, it was possible to prevent the occurrence of the problems attributable to the condensation slip.

Basically, the control sequence in this embodiment was the same in structure as that in the first embodiment, except that in the case of this embodiment, the film heating area was different from the area in which the film temperature is detected. However, the fixing device 103 in this embodiment may be used in combination with the control in the second, third, or fourth embodiment.

### Embodiment 6

### Description of Image Forming Apparatus

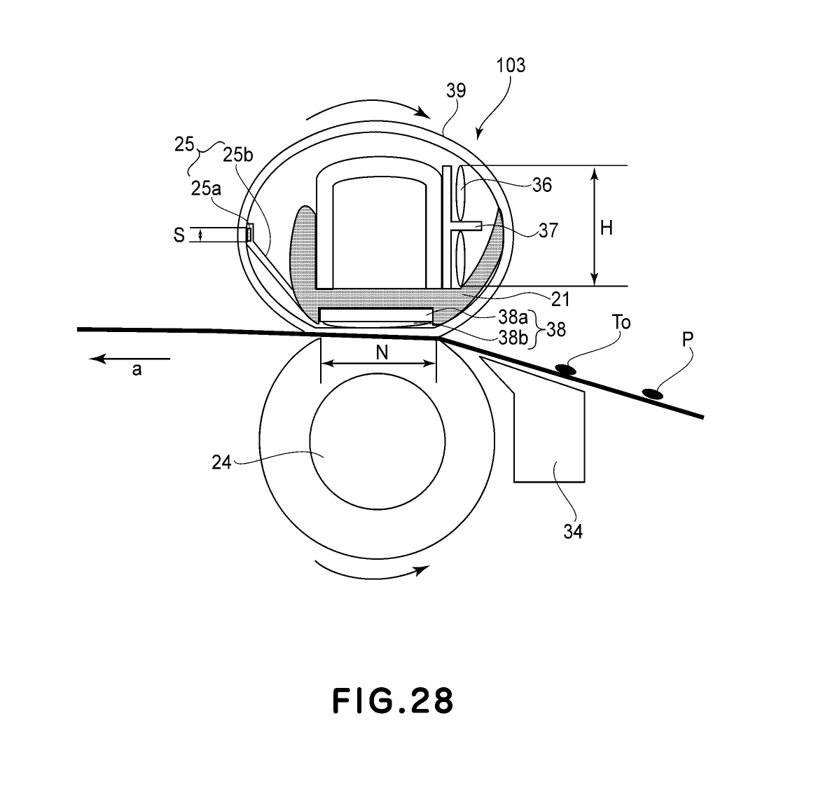

The image forming apparatus 100 in this embodiment is the same in structure as the image forming apparatus in the fifth embodiment, except that it has a fixing device 103 which has an induction heating coil 36 as a heating means. FIG. 28 is a sectional view of the fixing device 103 in this embodiment. The difference of the fixing device 103 in this embodiment from the fixing device 103 in the fifth embodiment is described with reference to FIG. 28.

As electrical current is induced in the fixation sleeve 39 (first rotational member) by the alternating magnetic field generated by an induction heating coil 36, in the fixation sleeve heating area H in which the fixation sleeve opposes the induction heating coil 36, heat is generated in the fixation sleeve 39 by the induced electrical current. The induction heating coil 36 is in connection with an unshown excitation circuit, being thereby enabled to generate high frequency waves, which is 20 kHz-500 kHz in frequency, by a switching electric power source.

The magnetic core 37 is a magnetic member for concentrating the magnetic flux of the magnetic field generated by the induction heating coil 36, to the heating section. As the material for the magnetic core 37, substances such as ferrite, Permalloy, etc., which are high in permeability, are suitable. Preferably, ferrite which is small in loss even if the alternating current is no less than 100 kHz in frequency, is used as the material for the magnetic core 37.

The sleeve backing plate 38, which is a low friction member, bears the pressure from the pressure roller 24. It is provided for the purpose of not only ensuring that the nip N remain stable, but also, minimizing the friction between the itself and the sleeve 39 to ensure that the sleeve 39 reliably rotates. The sleeve backing plate 38 has a substrative plate 38a, and a low friction layer 38b formed on the substrative plate 38 to minimize the friction between the sleeve backing plate 38 and the inward surface of the sleeve 39 in order to enable the sleeve 39 to smoothly slide on the sleeve backing plate 38. The substrative plate 38a in this embodiment is a piece of aluminum plate which is 10 mm in width, 370 mm in length, and 1 mm in thickness. The low friction layer 38b in this embodiment is formed of heat resistant glass, and is roughly 15 μm is thickness.

As the material for the sleeve 39, magnetic or nonmagnetic metallic substances that can be made to generate heat by magnetic induction are usable. Preferably, one of highly magnetic metals such as nickel (Ni), iron (Fe), highly magnetic stainless steel (SUS), nickel-cobalt alloy (Ni-o), Permalloy (Fe—Ni), etc, is used as the material for the sleeve 39. The sleeve 39 in this embodiment comprised a piece of stainless tube, which was 24 mm in internal diameter, 330 mm in length, and 30 μm, and a 15 μm thick PFA layer coated on the peripheral surface of the stainless tube. Thus, the sleeve 39 was 45 μm in overall thickness.

The thermistor 25 was the same in structure as the thermistor 25 in the fifth embodiment. It was disposed in contact with the inward surface of the sleeve 39. The fixing device 103 was structured so that the temperature sensing element 25a of the thermistor 25 detects the temperature of the sleeve 39, in the temperature detection area S, which is the area of contact between the temperature sensing element 25a and the sleeve 39.

As described above, the fixing device 103 in this embodiment is different, in the structure of the heating means, from the fixing device 103 in the fifth embodiment. However, the area of the fixing device 103 in this embodiment, in which the sleeve 39 is heated, is equivalent to the area of the fixing device 103 in the fifth embodiment, in which the film 22 is heated. Further, the area of the fixing device 103 in this embodiment, in which the temperature of the sleeve 39 is detected, is equivalent to the area of the fixing device 103 in the fifth embodiment, in which the temperature of the film 22 is detected.

In order to verify the effectiveness of this embodiment, the fixing device 103 in this embodiment, which was structured as described above, was installed in the image forming apparatus 100. Then, the image forming apparatus 100 was operated following the flowchart shown in FIG. 8, which shows the control sequence in the fifth embodiment, with reference to FIG. 6, which shows the length of conveyance start timing delay, calculation of the slip index, and condensation slip preventing method.

### <Results of Verification Tests>

The effectiveness of this embodiment upon the prevention of the condensation slip was verified by conveying sheets P of recording medium under the same conditions as those under which the effectiveness of the fifth embodiment was tested. The results of the verification tests for this embodiment were the same as those for the fifth embodiment. That is, the condensation slip did not occur regardless of the condition. Further, even in the case of the sheets P of recording medium, which were left unattended for a substantial length of time after being unpackaged, the slip index was 5 as in the case of the first embodiment, and therefore, it was possible to prevent the occurrence of the condensation slip by delay the conveyance start timing for the second sheet P by two seconds.

As described above, in the case of the fixing device 103 in this embodiment, the temperature detection area S, in which the temperature of the sleeve 39 is detected by the thermistor 25 is different from the heating area H in which the sleeve 39 is heated by the induction heating coil 39. Also in the case of this fixing device 103, the state of rotation of the sleeve 39 was detected by detecting, with the use of the thermistor 25, the amount of temperature reduction of the sleeve 39 which occurred during the temperature detection period. Then, the proper length by which the conveyance start timing was to be delayed was selected based on the detected state of rotation of the sleeve 39. Therefore, it was possible to prevent the occurrence of the problems attributable to the condensation slip.

In the case of the fixing device 103 this embodiment, the control sequence is basically the same as that in the first embodiment, and the heating area in which the sleeve 39 is heated is different from the temperature detection area. However, it is possible to use one of the control sequences in the second, third, and fourth embodiments in conjunction with the fixing device in this embodiment.

### Embodiment 7

### Description of Image Forming Apparatus

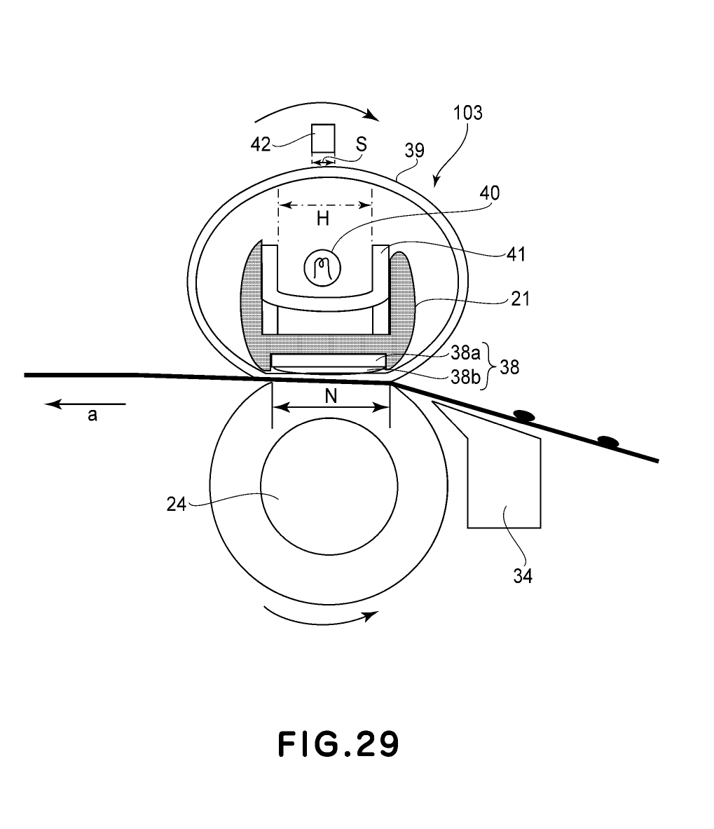

The image forming apparatus 100 in this embodiment is the same in structure as the image forming apparatus in the sixth embodiment, except that it has a fixing device 103 which uses a halogen lamp heater 40 as a heating means. FIG. 29 is a sectional view of the fixing device 103 in this embodiment. The difference of the fixing device 103 in this embodiment from the fixing device 103 in the sixth embodiment is described with reference to FIG. 29.

The fixation sleeve 39 in this embodiment is heated by the absorption of the radiant light, outputted by a heater 40, by the inward surface of the sleeve 39. The reflection plate 41 is made of aluminum. It is used to reflect the radiant light radiated downward in the drawing, toward the inward surface of the sleeve 39.

The temperature detection element 42 is a thermopile which is capable of detecting the temperature of an object, with no contact between itself and the object. The electric power supply to the heater 40 is controlled by the unshown control section, based on the result of the temperature detection by the temperature detection element 42, to keep the temperature of the sleeve 39 stable at the preset level. Unlike the fixing devices 103 in the fifth and sixth embodiments, the fixing device 103 in this embodiment is structured so that, in terms of the circumferential direction of the sleeve 39, the temperature detection area S falls within the heating area H in which the sleeve 39 is heated.

The effectiveness of this embodiment was verified by conducting verification tests in which the image forming apparatus 100 in this embodiment, which has the fixing device 103 structured as described above was operated with the use of the flowchart of control sequence shown in FIG. 8, with the reference to FIG. 6 which shows the relationship between the slip index and the length by which the conveyance start timing is delayed, to prevent the occurrence of the condensation slip, as the image forming apparatuses in the fifth and sixth embodiments were operated.

### <Results of Verification Tests>

The effectiveness of this embodiment upon the prevention of the condensation slip was verified by conveying sheets P of recording medium under the same condition as those under which sheets P were conveyed to verify the effectiveness of the fifth embodiment. The results of the verification were the same as those obtained by the verification tests conducted for the fifth embodiment. No condensation slip occurred in any of the verification tests. Further, even in the case of the sheets P left unattended for a substantial length of time after being unpackaged, the slip index was 5, which was the same as that in the case of the fifth embodiment. Thus, the occurrence of the condensation slip was prevented by delaying the conveyance start timing by two seconds.

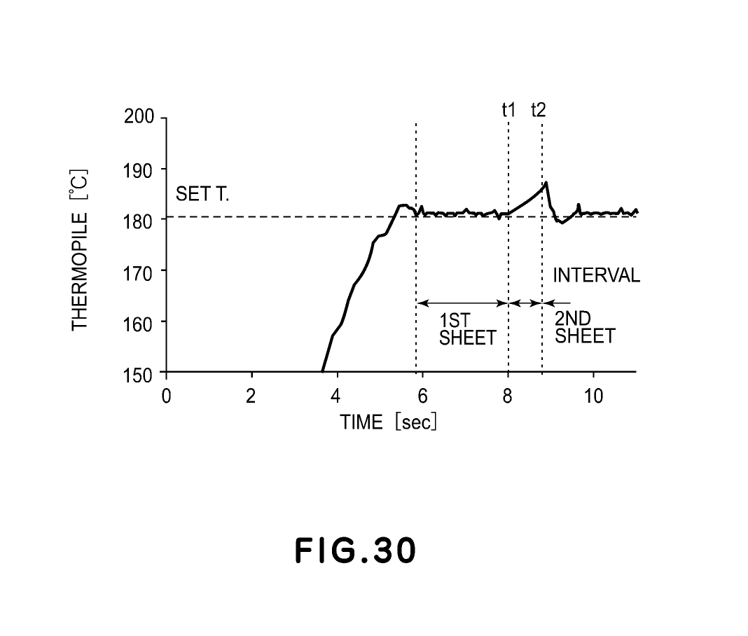

FIG. 30 shows the relationship between the thermopile temperature and set temperature in a printing operation in which the condensation slip occurred. In the case of this embodiment, the temperature detection area S falls within the heat area H in which the sleeve 39 is heated. Thus, the monitored thermopile temperature increased to 180° C., overshooting thereby the set temperature, during the recording medium interval between when the first sheet P was moved out of the nip N and when the second sheet P was moved into the nip N. Then, as the second sheet P began to be moved through the nip N, the monitored thermopile temperature slightly undershot, and settled at the set temperature thereafter.

The reason why the thermopile temperature overshot during the recording medium interval is that the sleeve 30 reduced in speed, or remained stationary, during the recording medium interval. As the sleeve 39 suddenly reduce in speed while it is rotating, the portion of the sleeve 39, which is the sleeve heating area H, is excessively heated, and therefore, the temperature detected by the thermopile, in the temperature detection area S increases. On the other hand, the portion of the sleeve 39, which is remaining stationary in the nip N, is continuously robbed of heat, reducing thereby in temperature. Thus, the temperature detected by the thermopile temporarily increases during the recording medium interval. Then, the thermopile detects the temperature drop with the timing with which it detects the temperature of the sleeve 30, which was stationary in the nip N during the recording medium interval.

The amount of the above described temperature overshoot and under shoot of the sleeve 39 is inversely proportional to the drop in the speed of the sleeve 39. Further, it is proportional to the length of time the sleeve 39 remains stationary.

As described above, in the case of the fixing device 103 in this embodiment, the sleeve heating area H in which the sleeve 39 is heated by the heater 40 falls within the area S in which the temperature of the sleeve 39 is detected by the temperature detection element 42. The changes in the state of rotation of the sleeve 39 is detected by detecting the increase in the temperature of the sleeve 39, which occurs while the temperature of the sleeve 39 is detected by the temperature detection element 42. Then, the proper length by which the conveyance start timing is to be delayed is selected based on the detected state of rotation of the sleeve 39. Thus, it was possible to prevent the occurrence of the problem attributable to the condensation slip.

The fixing device 103 in this embodiment was structured so that the heating area H in which the sleeve 39 is heated by the heater 40 falls within the area S in which the temperature of the sleeve 39 is detected by the temperature detection element 42. Further, basically, it was controlled with the use of the same controlling method as that used to control the fixing device 103 in the first embodiment. However, it is possible to control the fixing device 103 in this embodiment, structured as described above, with the use of any of the controlling methods used to control the fixing device 103 in the second, third, and fourth embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-114027 filed on Jun. 2, 2014, which is hereby incorporated by reference herein in its entirety.

What is claimed is:

1. An image forming apparatus for forming a toner image to a recording material, said image forming apparatus comprising:
an image forming station for forming an unfixed toner image on a recording material;
a fixing portion for fixing the unfixed toner image on the recording material by heating the recording material carrying the unfixed toner image in a nip while feeding the recording material, said fixing portion including a cylindrical film, a heater contacting an inner surface of said film, a roller cooperative with said heater to form the nip between said film and said roller;
a temperature detecting portion for detecting a temperature of said heater;
an electric power control portion for controlling electric power to be supplied to said heater so that a temperature detected by said temperature detecting portion is at a target temperature; and
a feed control portion for controlling feeding of the recording material;
wherein when the image is formed on a second recording material continuously after forming the image on the first recording material,
said temperature detecting portion detects a change of the temperature of said heater in a predetermined period in which said nip does not feed the recording material and which is after the first recording material passes through said nip and before the second recording material reaches said nip, and
said feed control portion changes a feeding interval between the first recording material and the second recording material in accordance with the change of the temperature.

2. The image forming apparatus according to claim 1, wherein said film is rotatable by rotation of said roller.

3. The image forming apparatus according to claim 1, wherein the change of the temperature is an integration of a difference between the detected temperature and the target temperature in the predetermined period.

4. An image forming apparatus for forming a toner image to a recording material, said image forming apparatus comprising:
an image forming station for forming an unfixed toner image on a recording material;
a fixing portion for fixing the unfixed toner image on the recording material by heating the recording material carrying the unfixed toner image in a nip while feeding the recording material, said fixing portion including a rotatable heating member, a heater for heating said rotatable heating member, a pressing rotatable member cooperative with said rotatable heating member to form the nip between said rotatable heating member and said rotatable heating member;
a temperature detecting portion for detecting a temperature of said rotatable heating member or said heater;
an electric power control portion for controlling electric power to be supplied to said heater so that a temperature detected by said temperature detecting portion is at a target temperature; and
a feed control portion for controlling feeding of the recording material;
wherein when the image is formed on a second recording material continuously after forming the image on the first recording material,
said feed control portion is capable of executing an operation in a first mode or an operation in a second mode, wherein in the first mode, said feed control portion controls feeding of the recording material such that a feeding interval between the first recording material and the second recording material is a predetermined feeding interval, and wherein said temperature detecting portion detects a change of the temperature of said heater in a predetermined period in which said nip does not feed the recording material and which is after the first recording material passes through said nip and before the second recording material reaches said nip, and
said feed control portion controls the feeding interval between the first the recording material and the second recording material in accordance with the change of the temperature such that the feeding interval is longer than the predetermined interval.

5. The image forming apparatus according to claim 4, wherein the change of the temperature is an integration of a difference between the detected temperature and the target temperature in the predetermined period.

6. The image heating apparatus according to claim 4, further comprising an acquiring portion for acquiring a print ratio of the toner image, wherein
when the print ratio is smaller than a threshold, the operation in the first mode is executed, and when the print ratio is larger than the threshold the operation in the second mode is executed.

7. The image heating apparatus according to claim 4, further comprising an acquiring portion for acquiring an integrated value for each passage of the recording material in the second mode, wherein said feed control portion changes in the feeding interval of the recording material in accordance with a change of the integrated value.

8. The image heating apparatus according to claim 4, wherein said rotatable heating member includes a cylindrical film.

9. An image forming apparatus for forming a toner image to a recording material, said image forming apparatus comprising:
an image forming station for forming an unfixed toner image on a recording material;
a fixing portion for fixing the unfixed toner image on the recording material by heating the recording material carrying the unfixed toner image in a nip while feeding the recording material, said fixing portion including a rotatable heating member, a heater for heating said rotatable heating member, a pressing rotatable member cooperative with said rotatable heating member to form the nip between said rotatable heating member and said rotatable heating member;
a temperature detecting portion for detecting a temperature of said rotatable heating member or said heater;
an electric power control portion for controlling electric power to be supplied to said heater so that a temperature detected by said temperature detecting portion is at a target temperature;
a feed control portion for controlling feeding of the recording material; and
an acquiring portion for acquiring a integrated value of a difference between the detected temperature and the target temperature in a predetermined period in which said nip does not feed the recording material and which is after a previous recording material passes through said nip and before a current the recording material reaches said nip,
wherein said feed control portion controls feeding the recording material such that the feeding interval between the previous recording material and the current recording material is longer when the integrated value is larger than a threshold then when the integrated value is smaller than the threshold.

10. The image heating apparatus according to claim 9, wherein said rotatable heating member includes a cylindrical film.
